(19) United States
(12) Patent Application Publication
(10) Pub. No.: US 2026/0235979 A1
(43) Pub. Date: Aug. 13, 2026

(54) CLEANING DEVICE AND IMAGE FORMING APPARATUS

(71) Applicant: FUJIFILM Business Innovation Corp., Tokyo (JP)

(72) Inventors: Toshihiko KAMIYAMA, Kanagawa (JP); Yota KONDO, Kanagawa (JP); Kiyotoshi KANEYAMA, Kanagawa (JP)

(73) Assignee: FUJIFILM Business Innovation Corp., Tokyo (JP)

(21) Appl. No.: 19/283,178

(22) Filed: Jul. 28, 2025

(30) Foreign Application Priority Data
Feb. 12, 2025 (JP) 2025-020709

(51) Int. Cl. G03G 15/16; G03G 21/00; G03G 21/16

(52) U.S. Cl. CPC G03G 15/161; G03G 21/0011; G03G 21/0035; G03G 21/0076; G03G 21/1647; G03G 2221/0005; G03G 2221/1618

(57) ABSTRACT

A cleaning device includes a housing of the cleaning device that is moved to be inserted into and extracted from a cleaning mounting portion of an image forming apparatus including an image holding body that holds an image and rotates, and is attached to and detached from the cleaning mounting portion, a cleaning member that is provided in the housing and cleans the image holding body by bringing a part of the cleaning member into contact with the image holding body, a protective member that is provided to be movable in the housing, moves to a shielded position where the part of the cleaning member is shielded from an exposed position where the part is exposed, and protects the part, and a moving mechanism that is provided to be movable in the housing and moves the protective member between the exposed position and the shielded position in conjunction with an operation of moving the housing to be inserted into and extracted from the cleaning mounting portion.

### CROSS-REFERENCE TO RELATED APPLICATIONS

This application is based on and claims priority under 35 USC 119 from Japanese Patent Application No. 2025-020709 filed Feb. 12, 2025.

### BACKGROUND

### (i) Technical Field

The present invention relates to a cleaning device and an image forming apparatus.

### (ii) Related Art

A cleaning device including a blade, a scraper, and a guard member is disclosed in JP2006-84688A (paragraphs 0037 to 0046, FIGS. 2 to 5).

The blade is a member that comes into contact with a surface of an object to be cleaned, which moves in a predetermined direction, and scrapes off toner adhering to the surface.

The scraper is a member that comes into contact with the surface of the object to be cleaned at a position spaced downstream in the movement direction of the object to be cleaned with respect to the blade.

The guard member is a member that is disposed to close a gap between the blade and the scraper.

A cleaning device that is attachable to and detachable from a main body of an image forming apparatus including an image carrier is disclosed in JP2020-144243A (Claims 1, 7, and 8, paragraphs 0039 and 0042, FIGS. 5 and 6).

The cleaning device includes a cleaning member and a shutter member.

The cleaning member is a member that comes into contact with the image carrier via an opening portion formed in a housing of the cleaning device to remove adhering toner.

The shutter member is a member that opens and closes the opening portion in conjunction with an operation in which the cleaning device is attached to and detached from the main body of the image forming apparatus.

The shutter member is restricted by a stopper member so as not to come into contact with the image carrier in a case where the cleaning device is mounted on the main body of the image forming apparatus.

In addition, the cleaning device is pressed in a direction toward the image carrier by a pressure mechanism of a cam, and a position of the cleaning device is determined. In a case where the pressure applied by the pressure mechanism is released, the cleaning device is pushed in a direction away from the image carrier by the pushing mechanism.

In a case of attaching and detaching the cleaning device, an operation of rotating an operation lever to rotate the cam of the pressure mechanism is required.

### SUMMARY

Aspects of non-limiting embodiments of the present disclosure relate to a cleaning device and an image forming apparatus that is capable of easily moving the protective member that shields and protects the part of the cleaning member in the cleaning device between the exposed position and the shielded position as compared with a case where an operation other than the operation of moving the cleaning device to be inserted and extracted at the time of attaching and detaching the cleaning device to and from the cleaning mounting portion of the image forming apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a cleaning device including a housing of the cleaning device that is moved to be inserted into and extracted from a cleaning mounting portion of an image forming apparatus including an image holding body that holds an image and rotates, and is attached to and detached from the cleaning mounting portion, a cleaning member that is provided in the housing and cleans the image holding body by bringing a part of the cleaning member into contact with the image holding body, a protective member that is provided to be movable in the housing, moves to a shielded position where the part of the cleaning member is shielded from an exposed position where the part is exposed, and protects the part, and a moving mechanism that is provided to be movable in the housing and moves the protective member between the exposed position and the shielded position in conjunction with an operation of moving the housing to be inserted into and extracted from the cleaning mounting portion.

### BRIEF DESCRIPTION OF THE DRAWINGS

Exemplary embodiment(s) of the present invention will be described in detail based on the following figures, wherein:

FIG. 1 is a schematic view of an image forming apparatus including a cleaning device according to a first exemplary embodiment;

FIG. 2A is a schematic perspective view of a cleaning mounting portion of an image forming apparatus and a cleaning device mounted to the cleaning mounting portion, and FIG. 2B is a schematic perspective view showing a part of the cleaning mounting portion of FIG. 2A;

FIG. 3 is a schematic perspective view of the cleaning device according to first exemplary embodiment;

FIG. 4 is a schematic cross-sectional view showing a usage state of the cleaning device;

FIG. 5A is a schematic perspective view of the cleaning device in a case where a front cover and a side surface cover are removed, and FIG. 5B is a schematic perspective view of the cleaning device in FIG. 5A as viewed from another angle;

FIG. 6A is a schematic cross-sectional view showing a state of a main part of the cleaning device in a case where a protective member is at an exposed position, and FIG. 6B is a schematic cross-sectional view showing a state of the main part of the cleaning device in a case where the protective member is at a shielded position;

FIG. 7A is a schematic perspective view of the protective member and a moving mechanism as viewed obliquely downward, and FIG. 7B is a schematic perspective view of the protective member and the moving mechanism a viewed obliquely upward;

FIG. 8 is a schematic side view as viewed from a side of the cleaning device of FIG. 5B;

FIG. 9A is an explanatory view showing a state of the moving member and the displacement member in a case where the protective member is at the shielded position, FIG. 9B is an explanatory view showing a state of the moving member and the displacement member in a case where the protective member is between the shielded position and the exposed position, and FIG. 9C is an explanatory view showing a state of the moving member and the displacement member in a case where the protective member is at the exposed position;

FIGS. 10A to 10C are explanatory views showing an outline of an operation of attaching and detaching the cleaning device and operations of the protective member and the moving mechanism, in which FIG. 10A shows a state in a case where the cleaning device is not mounted, FIG. 10B shows a state in a case where the cleaning device is being attached or detached, and FIG. 10C shows a state in a case where the cleaning device is completely mounted;

FIG. 11 is an explanatory view showing an outline of a change in a state in a case where the cleaning device is attached to or detached from the cleaning mounting portion;

FIG. 12A is a schematic perspective view showing a state of an end portion on a front side in a movement stage such as an initial mounting of the cleaning device, and FIG. 12B is a schematic perspective view showing a state of an end portion on a rear side of the cleaning device in FIG. 12A;

FIG. 13A is a schematic perspective view showing a state of the protective member and the moving mechanism in a stage such as an initial mounting of the cleaning device, and FIG. 13B is another schematic perspective view showing the state of the protective member and the moving mechanism in FIG. 13A;

FIG. 14A is a schematic perspective view showing a state of an end portion on a front side in a passing stage at a position in front of a mounting completion position of the cleaning device, and FIG. 14B is a schematic perspective view showing a state of an end portion on the rear side of the cleaning device in FIG. 14A;

FIG. 15A is a schematic perspective view showing a state of the protective member and the moving mechanism in a passing stage at a position in front of a mounting completion position of the cleaning device, and FIG. 15B is another schematic perspective view showing the state of the protective member and the moving mechanism in FIG. 15A;

FIG. 16A is a schematic perspective view showing a state of an end portion on a front side in a passing stage between a mounting completion position of the cleaning device and a position in front of the mounting completion position, and FIG. 16B is a schematic perspective view showing a state of an end portion on the rear side of the cleaning device in FIG. 16A;

FIG. 17A is a schematic perspective view showing a state of the protective member and the moving mechanism in a passing stage between the mounting completion position of the cleaning device and the position in front of the mounting completion position, and FIG. 17B is another schematic perspective view showing the state of the protective member and the moving mechanism in FIG. 17A;

FIG. 18A is a schematic perspective view showing a state of an end portion on a front side in a passing stage immediately before a mounting completion position of the cleaning device, and FIG. 18B is a schematic perspective view showing a state of an end portion on the rear side of the cleaning device in FIG. 18A;

FIG. 19A is a schematic perspective view showing a state of the protective member and the moving mechanism in a passing stage immediately before a mounting completion position of the cleaning device, and FIG. 19B is another schematic perspective view showing the state of the protective member and the moving mechanism in FIG. 19A; and

FIGS. 20A to 20C are schematic views showing a modification example of the moving mechanism, FIG. 20A shows a state before the cleaning device is mounted, FIG. 20B shows a state in a case where the cleaning device is being attached or detached, and FIG. 20C shows a state in a case where the cleaning device is completely mounted.

### DETAILED DESCRIPTION

Exemplary embodiments of the present invention will be described below.

### First Exemplary Embodiment

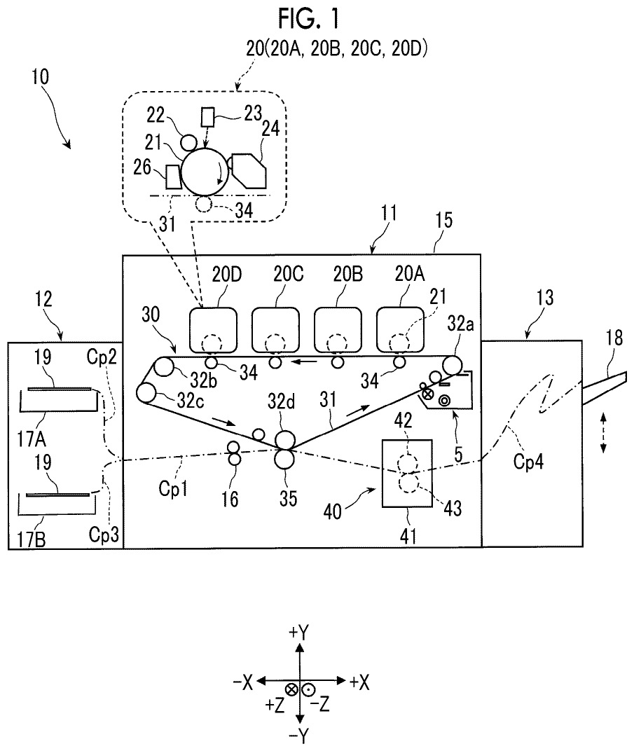

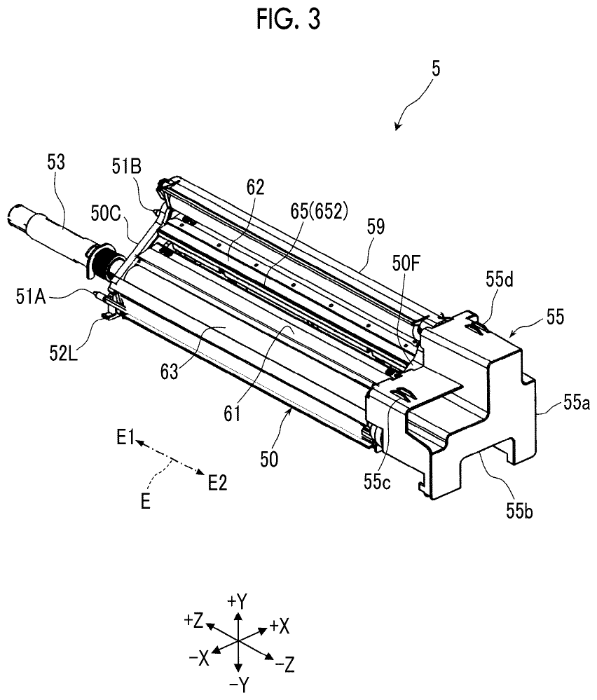

FIG. 1 is a schematic view of an image forming apparatus 10 including a cleaning device 5 according to a first exemplary embodiment. FIG. 3 is a perspective view of the cleaning device 5 according to the first exemplary embodiment.

In the present specification and the drawings, substantially identical components are denoted by identical reference numerals. Further, a repeated description of the identical components will be omitted in the present specification.

An arrow +X shown in the drawings indicates a right direction in a case where the image forming apparatus 10 and the like are viewed from a front side, and an arrow −X indicates a left direction in that case. In addition, an arrow +Y indicates an upward direction of the image forming apparatus 10 and the like, and an arrow −Y indicates a downward direction of the image forming apparatus 10 and the like. Further, reference symbol +Z indicates a depth direction in a case where the image forming apparatus 10 and the like are viewed from the front side, and reference symbol −Z indicates a front direction in that case.

In addition, a symbol with “×” inside “○” in the drawings indicates a direction vertically oriented from a front side to a rear side of the drawing sheet. In addition, a symbol with “⋅” inside “○” indicates a direction vertically oriented from the rear side to the front side of the drawing sheet.

### (1) Image Forming Apparatus

The image forming apparatus 10 is an apparatus that forms an image on a sheet 19. The image is an object including information such as text, a figure, a photograph, and a pattern that can be visually recognized.

The image forming apparatus 10 according to the first exemplary embodiment is configured with an image forming unit 11, a sheet supply unit 12, a post-processing unit 13, and the like.

The image forming unit 11 is a portion that forms an image consisting of developer, transfers the image onto the sheet 19, and fixes the image to the sheet 19.

The image forming unit 11 is configured to be disposed inside a housing 15 with an image creating device 20, a transfer device 30, a fixing device 40, a sheet transport path Cp1, and the like.

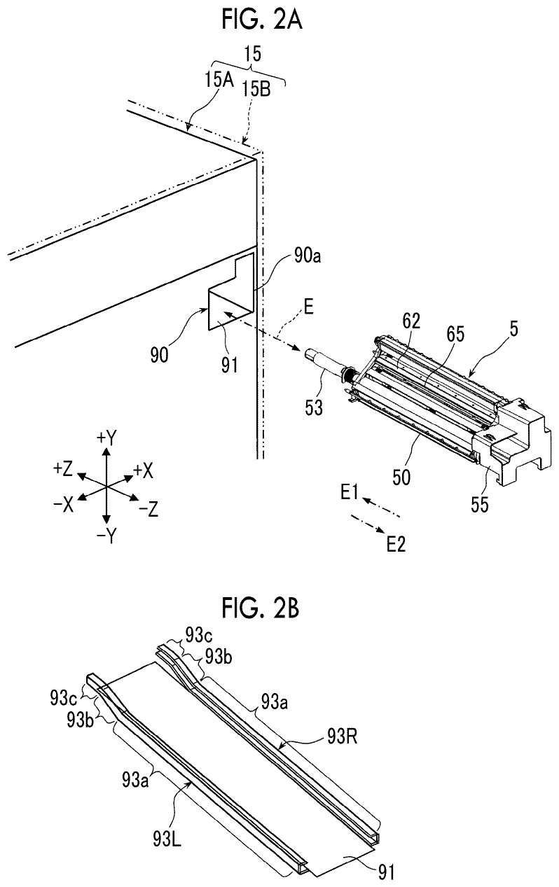

The housing 15 is a box-shaped structure configured with a frame-shaped main body 15A and an exterior body 15B (refer to FIGS. 2A and 2B, and the like). The exterior body 15B also includes an opening and closing door and the like.

The image creating device 20 is a device that creates an unfixed image consisting of the developer based on image information. The unfixed image is specifically a toner image.

As the image creating device 20, a device using an image forming method such as an electrophotographic method is used.

The image creating device 20 is configured with four image creating devices 20A, 20B, 20C, and 20D that exclusively form images of four colors (A, B, C, and D). The four colors (A, B, C, and D) are, for example, yellow, magenta, cyan, and black.

All of the image creating devices 20A, 20B, 20C, and 20D include a photoreceptor 21, a charging device 22, an image exposure device 23, a developing device 24, a first cleaning device 26, and the like.

The photoreceptor 21 is a drum-shaped structure that has a photosensitive layer on an outer peripheral surface and rotates in a direction indicated by the arrow. The charging device 22 is a device that performs a charging operation of charging the outer peripheral surface of the photoreceptor 21 to a predetermined surface potential. The image exposure device 23 is a device that performs an image exposure operation of irradiating the charged outer peripheral surface of the photoreceptor 21 with light corresponding to image information and forms an electrostatic latent image. The image information is obtained by being input to the image forming apparatus 10 from the outside and is subjected to image processing as necessary.

The developing device 24 is a device that performs a developing operation of developing the electrostatic latent image formed on the outer peripheral surface of the photoreceptor 21 with developer of a corresponding color to form a toner image. The developing device 24 performs a developing operation by handling one of the above developer of four colors.

The first cleaning device 26 is a device that performs a cleaning operation of removing an unnecessary object such as toner remaining on the outer peripheral surface of the photoreceptor 21 to clean the outer peripheral surface.

The transfer device 30 is a device that performs a transfer operation of relaying the toner image formed by the image forming unit 11 and transporting the toner image to a position where the toner image is transferred onto the sheet 19.

An intermediate transfer belt 31, a plurality of support rolls 32a to 32d, a primary transfer device 34, a secondary transfer device 35, a cleaning device 5, and the like are disposed in the transfer device 30. The transfer device 30 in the first exemplary embodiment is a so-called intermediate transfer type device.

The intermediate transfer belt 31 is an example of an image holding body that holds an image. An endless belt that is capable of holding an unfixed toner image by an electrostatic action is used as the intermediate transfer belt 31. The intermediate transfer belt 31 is wound around the plurality of support rolls 32a to 32d disposed at predetermined positions and is rotated in a direction indicated by an arrow.

The support roll 32a is a drive roll that rotates the intermediate transfer belt 31. The support roll 32b is a driven roll that supports the intermediate transfer belt 31 in cooperation with the support roll 32a to form a primary transfer surface. The support roll 32c is a functional roll that applies a predetermined tension to the intermediate transfer belt 31 and suppresses meandering. The support roll 32d is a back roll at a secondary transfer position.

The primary transfer device 34 is a device that performs primary transfer of the toner image formed on each of the photoreceptors 21 of the image creating devices 20A, 20B, 20C, and 20D to the intermediate transfer belt 31.

As the primary transfer device 34, a device using the primary transfer roll is used. The primary transfer roll is a contact rotating body that is driven to rotate at a position where a primary transfer current is supplied and faces the photoreceptor 21 with the intermediate transfer belt 31 interposed therebetween.

A position where the primary transfer device 34 faces the intermediate transfer belt 31 is a primary transfer position where the primary transfer operation is performed.

The secondary transfer device 35 is a device that secondarily transfers the toner image primarily transferred to the intermediate transfer belt 31 to the sheet 19.

A device using a secondary transfer roll is used as the secondary transfer device 35. The secondary transfer roll is a contact rotating body that is driven to rotate at a position where a secondary transfer current is supplied and faces the support roll 32d with the intermediate transfer belt 31 interposed therebetween.

A position where the secondary transfer device 35 faces the intermediate transfer belt 31 is a secondary transfer position where the secondary transfer operation is performed.

The cleaning device 5 is a device that performs a cleaning operation of removing an unnecessary object such as toner remaining on an outer peripheral surface of the intermediate transfer belt 31 to clean the outer peripheral surface. The cleaning device 5 may also be called, for example, a belt cleaning device, because the cleaning device 5 cleans the outer peripheral surface of the intermediate transfer belt 31.

The cleaning device 5 is disposed to clean the outer peripheral surface of a front-side portion of the intermediate transfer belt 31 that is supported by the support roll 32a.

Details of the cleaning device 5 will be described later.

The fixing device 40 is a device that performs a fixing operation of fixing the unfixed toner image, which is transferred to the sheet 19, to the sheet 19.

The fixing device 40 is configured by disposing a heating rotating body 42, a pressurizing rotating body 43, and the like inside a fixing housing 41. A roll-type rotating body or a belt-type rotating body is used as the heating rotating body 42 and the pressurizing rotating body 43. In the fixing device 40, a fixing process is performed by passing the sheet 19 through a nip portion where the heating rotating body 42 and the pressurizing rotating body 43 are in contact with each other.

The sheet transport path Cp1 is a transport path for transporting the sheet 19 to a predetermined place inside the housing 15.

The sheet transport path Cp1 has a transport path for transporting the sheet 19, which is supplied to the image forming unit 11, to the fixing device 40 after transporting the sheet 19 to the secondary transfer position. In addition, the sheet transport path Cp1 has a transport path for transporting the sheet 19 that has passed through the fixing device 40 to the outside of the image forming unit 11.

The sheet transport path Cp1 is configured by disposing a plurality of transport rolls, transport guide members, and the like (not shown). A pair of transport rolls 16 that correct the skewed state and send the sheet 19 to the secondary transfer position at a predetermined timing are disposed in the sheet transport path Cp1.

The sheet supply unit 12 is a portion that accommodates the sheet 19 and supplies the sheet 19 to the image forming unit 11.

The sheet supply unit 12 is configured by disposing, in the housing, accommodating bodies 17A and 17B, a feeding device (not shown), sheet transport paths Cp2 and Cp3, and the like.

The accommodating bodies 17A and 17B are structures that accommodate the sheet 19 and are disposed to be pulled out with respect to the housing. The number of the accommodating bodies 17A and 17B is not limited to two. The feeding device is a device that feeds the sheet 19 one by one from the accommodating bodies 17A and 17B.

The sheet transport path Cp2 is a transport path that transports the sheet 19 fed out from the accommodating body 17A toward the sheet transport path Cp1 of the image forming unit 11. The sheet transport path Cp3 is a transport path that transports the sheet 19 fed out from the accommodating body 17B toward the sheet transport path Cp1 of the image forming unit 11.

The sheet 19 is a sheet-like medium on which an image can be formed and transported. A sheet-like medium having a predetermined size, type, and the like is used as the sheet 19.

The post-processing unit 13 is a portion that performs a predetermined post-processing on the sheet 19 on which the image is formed by the image forming unit 11.

The post-processing unit 13 is configured by disposing a post-processing device (not shown), a sheet transport path Cp4, a sheet discharge tray 18, and the like inside the housing.

The post-processing device is a device such as a binding device, a hole punching device, and a folding device.

The sheet transport path Cp4 is a transport path for transporting the sheet 19, which is transported from the image forming unit 11, to the post-processing device or another place.

The sheet discharge tray 18 is a structure that accommodates the sheet 19 or the sheet bundle on which the post-processing is completed. The sheet discharge tray 18 is provided to move up and down in an up-down direction, for example, in accordance with the accommodation capacity of the sheet 19.

### (2) Image Forming Operation

In the image forming apparatus 10, for example, an image forming operation described below is performed.

Here, a case where all of the image creating devices 20A, 20B, 20C, and 20D operate to form a color image will be described as an example.

In a case where a control device (not shown) receives an instruction for the image forming operation, the image forming apparatus 10 starts the image forming unit 11, the sheet supply unit 12, the post-processing unit 13, and the like.

In this case, in the image forming unit 11, a charging operation, an image exposure operation, a developing operation, and the like are executed on each of the photoreceptors 21 rotating in the image creating devices 20A, 20B, 20C, and 20D.

In addition, the image forming unit 11 also executes a transfer operation of the transfer device 30 and a fixing operation of the fixing device 40.

Further, in the sheet supply unit 12, a sheet feeding operation is executed in accordance with a timing of the secondary transfer operation in the image forming unit 11.

Accordingly, in the image creating devices 20A, 20B, 20C, and 20D, the toner images of the four colors are separately formed on the respective photoreceptors 21.

Specifically, a yellow toner image is formed on the photoreceptor 21 in the image creating device 20A. A magenta toner image is formed on the photoreceptor 21 in the image creating device 20B. A cyan toner image is formed on the photoreceptor 21 in the image creating device 20C. A black toner image is formed on the photoreceptor 21 in the image creating device 20D.

Subsequently, in the transfer device 30, the primary transfer operation and the secondary transfer operation are performed.

In addition, in the sheet supply unit 12, the sheet feeding operation is executed.

Accordingly, in the transfer device 30, the toner images formed on the respective photoreceptors 21 of the image creating devices 20A, 20B, 20C, and 20D are sequentially primarily transferred to the intermediate transfer belt 31 at the respective primary transfer positions.

On the other hand, in the sheet supply unit 12, a predetermined sheet 19 is transported to be supplied to the image forming unit 11 through any of the sheet transport paths Cp2 and Cp3. In the image forming unit 11, the supplied sheet 19 is fed to the secondary transfer position through the sheet transport path Cp1 at a predetermined timing.

In addition, in the transfer device 30, the toner image primarily transferred in a superimposed manner onto the intermediate transfer belt 31 is collectively secondarily transferred to the sheet 19 at the secondary transfer position.

Subsequently, in the fixing device 40, the sheet 19 having the secondary-transferred toner image is fed to pass through the nip portion and is subjected to the fixing process.

As a result, a full-color image formed of the above four colors of toners is fixed and formed on one surface of the sheet 19.

Next, the post-processing unit 13 executes a predetermined post-processing operation on the sheet 19 on which the image is formed by the image forming unit 11.

The post-processed sheet 19 is discharged to and accommodated in the sheet discharge tray 18.

In the post-processing unit 13, the post-processing is not performed at all, and the sheet 19 on which the image is formed can be discharged and accommodated in the sheet discharge tray 18 as it is.

The image forming apparatus 10 performs the above series of operations to end a basic image forming operation of forming an image on one surface of a single sheet 19.

In the image forming operation, the first cleaning device 26 cleans the outer peripheral surface of each of the photoreceptors 21 of the image creating devices 20A, 20B, 20C, and 20D.

In the image forming operation, the cleaning device 5 cleans the outer peripheral surface of the intermediate transfer belt 31 in the transfer device 30.

### (3) Cleaning Mounting Portion in Image Forming Apparatus

The image forming apparatus 10 is provided with a cleaning mounting portion 90 in a part of the housing 15, on which the cleaning device 5 is attachably and detachably mounted (refer to FIGS. 2A and 2B).

The cleaning mounting portion 90 is disposed in a state of being present in a portion on a lower side of a portion of the intermediate transfer belt 31 supported by the support roll 32a.

In addition, the cleaning mounting portion 90 is formed as a mounting space extending from a front side to a predetermined position on a rear side of the housing 15. The mounting space is a space that extends substantially parallel to a rotating shaft of the support roll 32a and has a size and a shape in which the cleaning device 5 can be stored.

In addition, the cleaning mounting portion 90 is used in a state where an opening and closing door (not shown) provided in the exterior body 15B of the housing 15 is opened and an inlet 90a is exposed.

Further, the cleaning mounting portion 90 is provided with a support plate 91, a pair of right and left guide members 93L and 93R, and the like.

The support plate 91 is a plate material disposed at a portion that is a bottom of the mounting space.

The guide members 93L and 93R are members that guide a movement path in a case where the insertion and extraction movement is performed when a housing 50 of the cleaning device 5, which will be described later, is attached to and detached from the guide members 93L and 93R.

The guide members 93L and 93R are provided as guide rails on the right and left side ends of the support plate 91 in a longitudinal direction. The guide members 93L and 93R are disposed with guide portions thereof facing each other. The guide portion is formed as a horizontal groove that is closed by upper and lower surfaces and an outer side surface, with the inner opposing side surface.

The guide members 93L and 93R are used in a state where guided portions (52L and 52R) of the cleaning device 5 to be described later are fitted into the respective guide portions.

Details of the guide members 93L and 93R will be described later.

In the image forming apparatus 10, the cleaning device 5 can be freely attached and detached by moving the cleaning device 5 to be inserted and extracted with respect to the cleaning mounting portion 90.

The two-headed arrow E shown in FIGS. 2A and 2B, and the like is a movement direction of insertion and extraction in a case of attachment and detachment of the cleaning device 5.

The direction indicated by an arrow E1 of the two-arrow E is an insertion movement direction in a case of the insertion during the insertion and extraction. In addition, the direction indicated by an arrow E2 of the two-arrow E is an extraction movement direction in a case of the extraction during the insertion and extraction.

### (4-1) Cleaning Device

Next, the cleaning device 5 will be described in detail.

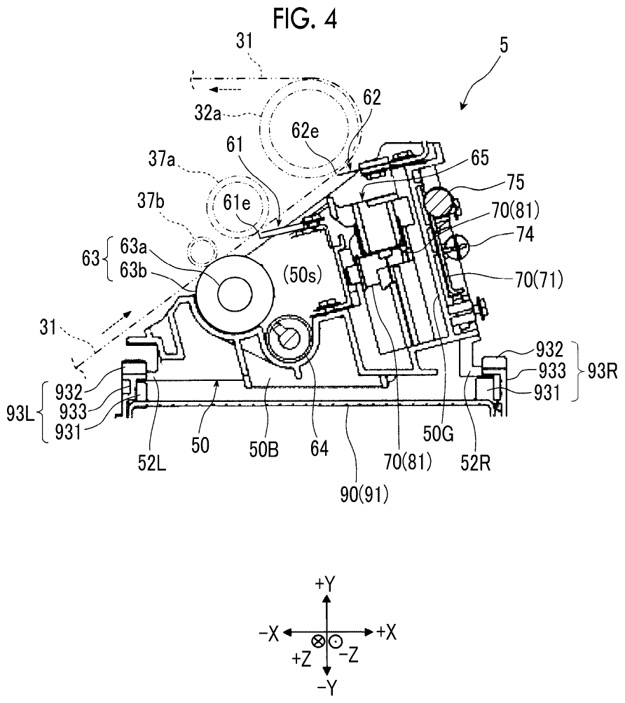

As shown in FIGS. 3 and 4, the cleaning device 5 has the housing 50.

In addition, the cleaning device 5 is provided with a blade 61, a scraper 62, a rotating brush 63, a transport member 64, and the like, which are disposed in the housing 50.

The housing 50 is a container-shaped structure that extends along a movement direction E of the insertion and extraction at the time of attachment and detachment of the cleaning device 5 and has an elongated internal space 50s of which an upper surface side is open.

The housing 50 has a shape including a bottom surface portion 50B, a rear surface portion 50C, a front surface portion 50F, a side surface portion 50G, and the like.

The bottom surface portion 50B is a portion that is a bottom in a case where the cleaning device 5 is mounted. The rear surface portion 50C is a wall portion that is a rear side in a case where the cleaning device 5 is mounted. The front surface portion 50F is a wall portion that is a front side in a case where the cleaning device 5 is mounted. The side surface portion 50G is a wall portion along the movement direction E of the insertion and extraction in a case where the cleaning device 5 is mounted.

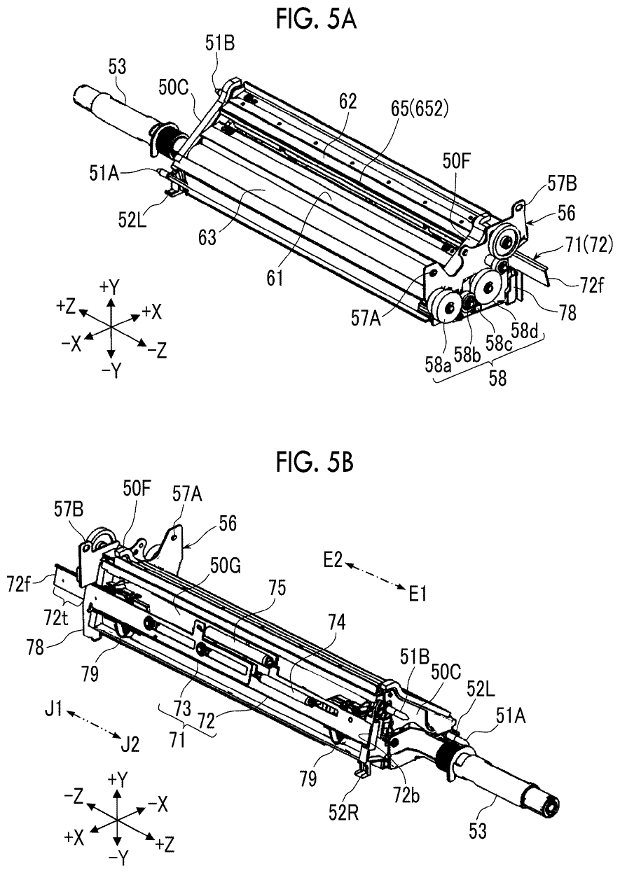

A pair of positioning pins 51A and 51B, a pair of right and left guided portions 52L and 52R, a carrying-out pipe 53, and the like are provided in the rear surface portion 50C (refer to FIG. 5B).

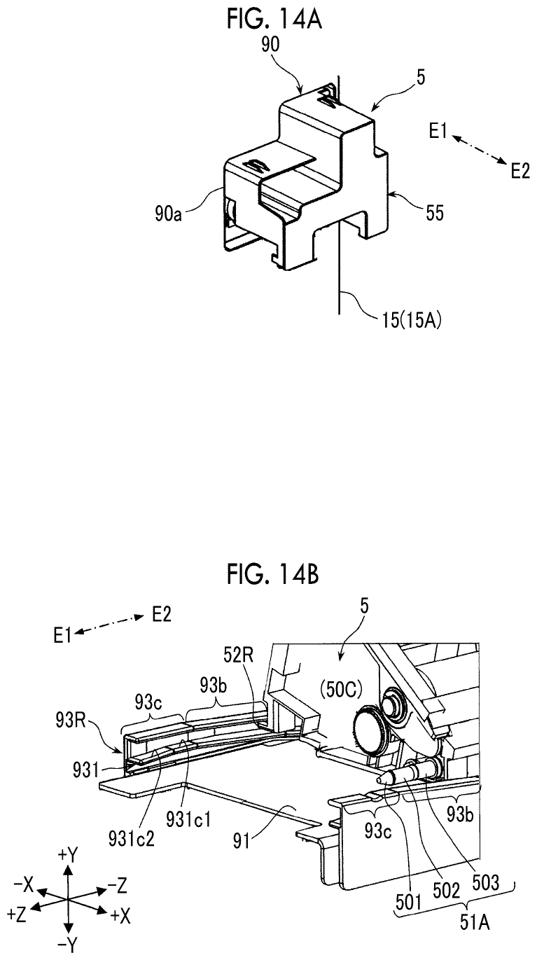

The positioning pins 51A and 51B are parts that are respectively fitted into positioning holes (not shown) provided on the rear side of the cleaning mounting portion 90. The positioning pins 51A and 51B are formed with a tapered guide surface portion 501, a temporary positioning surface portion 502, and a main positioning surface portion 503 (refer to FIG. 14B). The temporary positioning surface portion 502 is a cylindrical portion having an outer diameter slightly smaller than both the inner diameter of the positioning hole and the outer diameter of the main positioning surface portion 503. The positioning pins 51A and 51B determine a mounting completion position on the rear side of the cleaning device 5 in the cleaning mounting portion 90 in a case where the main positioning surface portion 503 is fitted into the positioning holes.

The guided portions 52L and 52R are portions guided by the guide members 93L and 93R of the cleaning mounting portion 90 in a case of attachment and detachment of the cleaning device 5. The guided portions 52L and 52R are formed as portions that respectively protrude outward to the right and left, orthogonal to the insertion and extraction movement direction E, at the lower right and left portion of the rear surface portion 50C. The guided portions 52L and 52R are fitted into the guide portions of the guide members 93L and 93R of the cleaning mounting portion 90 in a case of attachment and detachment of the cleaning device 5.

The carrying-out pipe 53 is a cylindrical member that causes the unnecessary object such as toner removed by the cleaning device 5 to pass therethrough to be carried out of the housing 50. A discharge port, an opening and closing shutter of the discharge port, and the like (not shown) are provided in the carrying-out pipe 53. The unnecessary object is discharged toward a collection container (not shown) disposed on the housing 15 side of the image forming apparatus 10 through the carrying-out pipe 53.

The front surface portion 50F is provided with an end portion cover 55, a front surface attachment plate 56, a pair of positioning holes 57A and 57B, a gear train 58, and the like (refer to FIGS. 3 and 5A).

A back surface cover 59 is attached to the side surface portion 50G (refer to FIG. 3).

The end portion cover 55 is a member that is attached to cover and hide the front surface portion 50F and the like.

The end portion cover 55 has a cover main body 55a having an external shape corresponding to a cross-sectional shape (at least a shape of the inlet 90a) of the cleaning mounting portion 90.

The cover main body 55a is provided with a grip portion 55b, guided protruding portions 55c and 55d, and the like (refer to FIG. 3).

The grip portion 55b is a portion to be gripped by hooking a hand of a worker in a case of performing an operation of attaching and detaching the cleaning device 5.

The guided protruding portions 55c and 55d are a pair of parallel protruding plates that are guided by a guide protrusion (not shown) on an inner upper surface near the inlet 90a of the cleaning mounting portion 90. The guided protruding portions 55c and 55d are guided in a state of being interposed between the pair of parallel protruding plates in a case where the cleaning device 5 is moved for insertion and extraction.

The front surface attachment plate 56 is a plate material used for attaching the cleaning device 5 to the cleaning mounting portion 90 or for attaching parts or the like to the front surface portion 50F.

The pair of positioning holes 57A and 57B, the gear train 58, and the like are provided in the front surface attachment plate 56 (refer to FIG. 5A).

The positioning holes 57A and 57B are holes into which positioning protrusions (not shown) disposed in the vicinity of the front end portion of the cleaning mounting portion 90 are fitted, respectively. The positioning holes 57A and 57B determine a mounting completion position on the front side of the cleaning device 5 in the cleaning mounting portion 90.

The gear train 58 is configured with a plurality of gears, such as an input connection gear 58a, a transmission gear 58b of the rotating brush 63, a transmission gear 58c of the transport member 64, and a transmission gear 58d to the downstream side. The input connection gear 58a is a gear meshing with a drive transmission gear of a drive device (not shown) that is disposed in the housing 15 of the image forming apparatus 10. The input connection gear 58a meshes with the drive transmission gear in a case where the cleaning device 5 is mounted on the cleaning mounting portion 90 and inputs the rotational power.

The back surface cover 59 is a member that is attached to cover and hide the side surface portion 50G.

The blade 61 is an example of a cleaning member and is a first cleaning member.

The blade 61 is an elastic plate material. A plate material configured with a material such as rubber, having a rectangular planar shape and a predetermined thickness is used as the elastic plate material.

The blade 61 is attached to the housing 50 such that an end portion 61e of one long side comes into contact with the outer peripheral surface of the intermediate transfer belt 31 in a case where the cleaning device 5 is mounted. The end portion 61e of the blade comes into contact with the intermediate transfer belt 31 over substantially the entire width direction thereof at a predetermined inclination angle.

A blade opposing roll 37a is provided in the transfer device 30 in relation to the blade 61 (refer to FIG. 4). The blade opposing roll 37a is a support roll that supports a portion of the intermediate transfer belt 31, which comes into contact with the end portion 61e of the blade, from an inner peripheral surface side.

The blade 61 scrapes off the unnecessary object such as toner adhering to the outer peripheral surface of the intermediate transfer belt 31 with the end portion 61e thereof to clean the outer peripheral surface.

The scraper 62 is another example of the cleaning member and is a second cleaning member that is disposed on the downstream side in the rotation direction of the intermediate transfer belt 31 with respect to the blade 61.

The scraper 62 is made of a thin rigid plate material. A plate material configured with a material such as metal, having a rectangular planar shape and a thickness thinner than the thickness of the blade 61 is used as the thin rigid plate material.

The scraper 62 is attached to the housing 50 such that an end portion 62e that is one long side comes into contact with the outer peripheral surface of the intermediate transfer belt 31 in a case where the cleaning device 5 is mounted. The end portion 62e of the scraper 62 is formed in, for example, a tapered shape from the viewpoint of improving the cleaning performance.

The end portion 62e of the scraper comes into contact with the intermediate transfer belt 31 at a position spaced apart from the blade 61 by a predetermined interval on the downstream side in the rotation direction of the intermediate transfer belt 31. In addition, the end portion 62e of the scraper comes into contact with the intermediate transfer belt 31 over substantially the entire width direction thereof at a predetermined inclination angle.

The scraper 62 comes into contact with an outer peripheral surface of a portion where the end portion 62e of the scraper 62 is supported by the support roll 32a of the intermediate transfer belt 31 (refer to FIG. 4).

The scraper 62 scrapes off the unnecessary object adhering to the outer peripheral surface of the intermediate transfer belt 31 after passing through the blade 61 with the end portion 62e, and cleans the outer peripheral surface.

The rotating brush 63 is another example of the cleaning member and is a third cleaning member that is disposed on the upstream side in the rotation direction of the intermediate transfer belt 31 with respect to the blade 61.

The rotating brush 63 is a roll-shaped structure in which a large number of brush bristles 63b having a predetermined length are provided in a cylindrical shape on an outer peripheral surface of a rotating shaft 63a.

The rotating brush 63 is rotatably attached to the housing 50 such that a tip of the brush bristle 63b comes into contact with the outer peripheral surface of the intermediate transfer belt 31 in a case where the cleaning device 5 is mounted. The rotational power is transmitted to the rotating shaft 63a of the rotating brush 63 from the image forming apparatus 10 side, and the rotating brush 63 rotates in a predetermined direction.

The tip of the brush bristle 63b comes into contact with the intermediate transfer belt 31 at a position spaced apart from the blade 61 by a predetermined interval on the upstream side in the rotation direction of the intermediate transfer belt 31. In addition, the tip of the brush bristle 63b comes into contact with the intermediate transfer belt 31 over a predetermined contact width across substantially the entire width direction.

A brush opposing roll 37b is disposed in the transfer device 30 in relation to the rotating brush 63 (refer to FIG. 4). The brush opposing roll 37b is a support roll that supports a portion of the intermediate transfer belt 31, which comes into contact with the rotating brush 63, from the inner peripheral surface side.

The rotating brush 63 scrapes off the unnecessary object such as toner and sheet dust adhering to the outer peripheral surface of the intermediate transfer belt 31 with the tip of the brush bristle 63b to clean the outer peripheral surface.

The transport member 64 is a member that transports the unnecessary object that is scraped off by the blade 61 or the like and falls into the internal space 50s, to the outside of the housing 50.

As the transport member 64, for example, a screw auger is used. The transport member 64 is disposed to extend to the inside of the carrying-out pipe 53. The transport member 64 rotates in a predetermined direction as the rotational power is transmitted from the image forming apparatus 10 side.

### (4-2) Protective Member and Moving Mechanism in Cleaning Device

In addition, as shown in FIGS. 5A to 7B, the cleaning device 5 includes a protective member 65 and a moving mechanism 70.

### Protective Member

The protective member 65 is a member that shields and protects, when necessary, the end portion 62e, which is an example of a part of the scraper 62.

The protective member 65 is provided in the housing 50 to be movable between an exposed position and a shielded position.

The exposed position is a position where the protective member 65 allows the end portion 62e of the scraper 62 to be exposed and used. The shielded position is a position where the protective member 65 shields the end portion 62e of the scraper 62 from the outside.

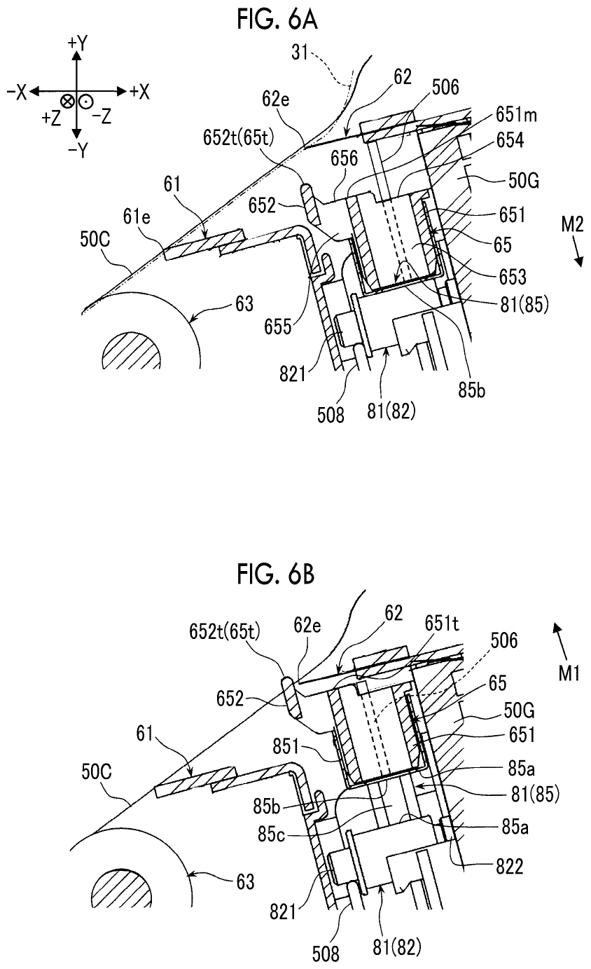

FIG. 6A and the like show a state of a main part of the cleaning device 5 in a case where the protective member 65 is at the exposed position. FIG. 6B and the like show a state of the main part of the cleaning device 5 in a case where the protective member 65 is at the shielded position.

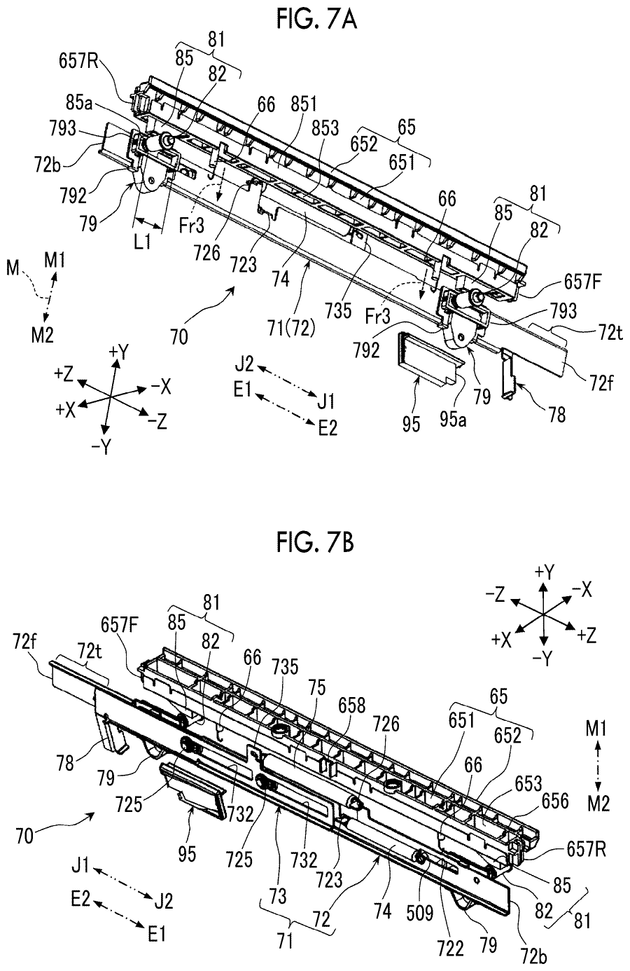

As shown in FIGS. 7A and 7B, the protective member 65 is configured with a main body portion 651 and a shielding portion 652.

The main body portion 651 is a portion that is disposed below the scraper 62 and extends from a front side end portion of the scraper 62 to a rear side end portion of the scraper 62. The main body portion 651 is formed, for example, as a structure having an elongated, linear shape.

A plurality of gaps 653 are provided in the longitudinal direction of the main body portion 651. The plurality of gaps 653 are spaces penetrating in an up-down direction. The spaces between the plurality of gaps 653 are each partitioned by partition plates 654.

The shielding portion 652 is a portion that shields the end portion 62e of the scraper 62 in a state in which unnecessary contact with the outside can be avoided.

The shielding portion 652 is formed as a plate-shaped portion that stands upward at a position separated from an end portion 651m of one long side of the main body portion 651.

In addition, the shielding portion 652 is provided such that an upper end 652t of the shielding portion 652 protrudes upward from an upper end 651t of the main body portion 651.

The protruding amount (height difference) of the upper end 652t of the shielding portion 652 is an amount that allows the end portion 62e of the scraper 62 to be covered and hidden from the outside in a case where the protective member 65 is moved to the shielded position.

Incidentally, the upper end 652t of the shielding portion 652 also serves as an upper end 65t as the end portion located at the most upper portion of the protective member 65.

Further, the shielding portion 652 is connected to and integrated with the end portion 651m of the long side of the main body portion 651 by a plurality of connecting plates 655. The plurality of connecting plates 655 are disposed at predetermined intervals.

The shielding portion 652 is provided with a plurality of gaps 656 partitioned by the connecting plate 655 between the shielding portion 652 and the main body portion 651 and penetrating in the up-down direction.

In addition, the main body portion 651 of the protective member 65 is provided with a pair of end portion guided portions 657F and 657R and a side portion guided portion 658 (refer to FIGS. 7A and 7B).

The pair of end portion guided portions 657F and 657R are guided portions provided at an end portion on a front side and an end portion on a rear side of the main body portion 651, respectively.

The end portion guided portions 657F and 657R are formed as protruding portions that face each other in parallel in the up-down direction. The protruding portions that are parallel to and face each other form a guided groove between the protruding portions that extend in a linear shape in the up-down direction and penetrates therethrough.

The end portion guided portions 657F and 657R are guided by guide plates 506 (refer to FIGS. 6A and 6B) that are provided on the inner surface sides of the front surface portion 50F and the rear surface portion 50C of the housing 50, respectively. The guide plate 506 is a plate-like protrusion that extends in a linear shape below the scraper 62 to be orthogonal to a lower surface of the scraper 62. The guide plate 506 guides the protective member 65 to move up and down in a direction indicated by the arrows M1 and M2.

The side portion guided portion 658 is a guided portion provided at a substantially central position of the other long side end portion of the main body portion 651.

The side portion guided portion 658 is formed as protruding portions that face each other in parallel in the up-down direction, similar to the end portion guided portions 657F and 657R. The protruding portions that are parallel to and face each other form a guided groove between the protruding portions that extend in a linear shape in the up-down direction and penetrates therethrough.

The side portion guided portion 658 is guided by a guide protruding portion (not shown) provided on the inner surface of the side surface portion 50G of the housing 50. The guide protruding portion is a rectangular parallelepiped-shaped protrusion extending in a linear shape in parallel with the above guide plate 506.

The protective member 65 is supported at three locations via a pair of end portion guided portions 657F and 657R and the side portion guided portion 658 and can move in the up-down direction.

Accordingly, the protective member 65 can move back and forth in a direction of toward and away from the scraper 62 inside the housing 50.

The protective member 65 is configured to move to the shielded position by moving in a direction toward the scraper 62. In addition, the protective member 65 is configured to move to the exposed position by moving in a direction away from the scraper 62.

Further, the protective member 65 is biased in a direction away from the scraper 62 by a restoring force Fr3 of the elastic member 66 (refer to FIGS. 7A and 7B).

Two tension coil springs are used as the elastic member 66, for example. One end of the tension coil spring of the elastic member 66 is attached to a part of the main body portion 651 of the protective member 65, and the other end is attached to a part of the housing 50.

Accordingly, the protective member 65 is maintained in a state where the protective member 65 is biased to the lower side and is likely to move to the exposed position as long as an external force is not applied.

### Moving Mechanism

The moving mechanism 70 is a mechanism that moves the protective member 65 between the exposed position and the shielded position.

In addition, the moving mechanism 70 is a mechanism that moves the protective member 65 back and forth in a direction M intersecting the movement direction E of the insertion and extraction to move the protective member 65 between the exposed position and the shielded position.

Further, the moving mechanism 70 is also a mechanism that moves the protective member 65 back and forth between the exposed position and the shielded position by changing the direction of the movement such that the protective member 65 is moved back and forth in the intersecting direction M.

In the cleaning device 5, the adoption of the moving mechanism 70 enables the switching movement of the protective member 65 between the exposed position and the shielded position to be performed easily.

That is, the switching movement is realized only by an operation of moving the cleaning device 5 to be inserted and extracted in a case of attaching and detaching the cleaning device 5 to and from the cleaning mounting portion 90, as will be described later.

The switching movement is performed by switching between the movement from the exposed position of the protective member 65 to the shielded position and the movement from the shielded position to the exposed position.

As shown in FIGS. 7A and 7B, the moving mechanism 70 includes a moving member 71 and a displacement member 81.

The moving member 71 is a member that is provided to be movable on the side surface portion 50G of the housing 50.

The displacement member 81 is a member that displaces the protective member 65 to move back and forth between the exposed position and the shielded position in conjunction with the movement of the moving member 71.

### Moving Member

The moving member 71 moves relatively in directions J1 and J2 opposite to the housing 50, which are along the movement direction E of the housing 50 in a case of insertion and extraction of the cleaning device 5.

That is, in a case where the housing 50 moves in the insertion movement direction E1, the moving member 71 moves in the direction J1 opposite to the housing 50 for a predetermined period of time. In addition, in a case where the housing 50 moves in the extraction movement direction E2, the moving member 71 moves in the direction J2 opposite to the housing 50 for a predetermined period of time.

Further, the moving member 71 is maintained in a state of being stopped by coming into contact with a part of the cleaning mounting portion 90 during the insertion process of the insertion and extraction. Accordingly, the moving member 71 is in a state of starting to move relative to the housing 50.

The moving member 71 in the first exemplary embodiment is configured as a member divided into the first member 72 and the second member 73.

The first member 72 is a plate material having of a substantially rectangular shape that extends long in the movement direction E of the housing 50.

The first member 72 is formed with a length in the longitudinal direction longer than a length of the protective member 65 in the longitudinal direction. The first member 72 is formed to have a size that always overlaps and faces the second member 73 even in a case where the second member 73 is relatively moved with respect to the first member 72.

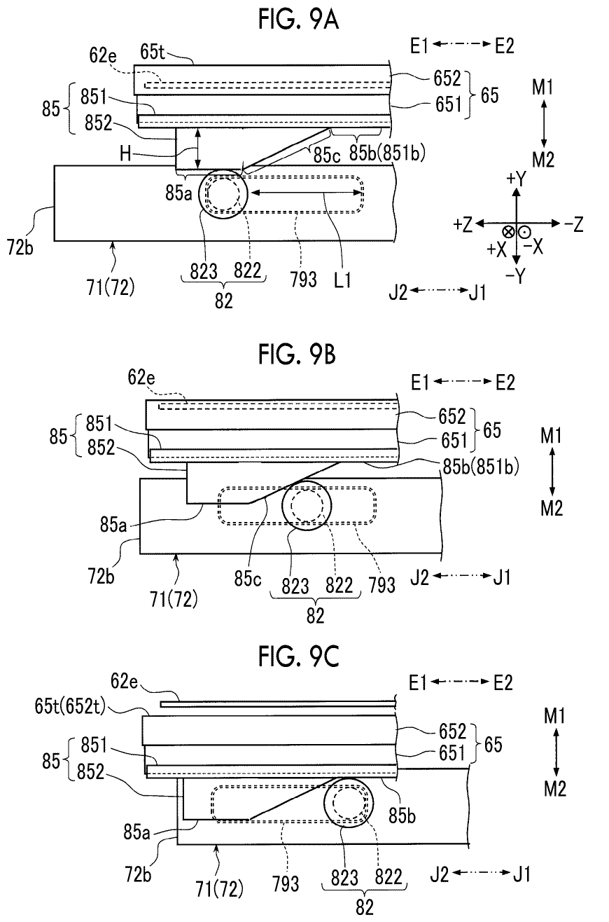

In addition, the first member 72 is provided to be movable with respect to the housing 50 by a predetermined first distance L1 along the movement direction E of the housing 50. The predetermined first distance L1 (refer to FIGS. 7A, 9A, and the like) will be described later.

The first member 72 is movably attached to two support bodies 79 that are disposed on and fixed to the side surface portion 50G of the housing 50.

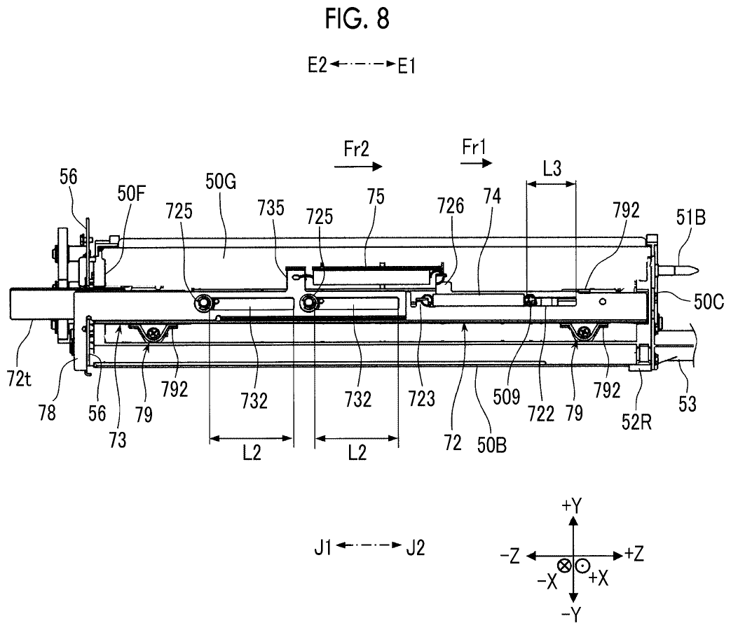

The first member 72 is attached in a state where an end portion 72f on the front side thereof protrudes to the front side of the front surface portion 50F of the housing 50 (refer to FIGS. 5A, 5B, and 8).

The protruding portion 72t of the first member 72 is a portion that overlaps a part of the second member 73 in a case where the second member 73 is relatively moved. The protruding portion 72t of the first member 72 is covered and hidden by the end portion cover 55 at the assembly completion stage of the cleaning device 5 (refer to FIG. 3).

In addition, the first member 72 is attached in a state where the end portion 72b on the rear side is located at substantially the same position as the rear surface portion 50C of the housing 50 (refer to FIGS. 5A, 5B, and 8).

The two support bodies 79 are disposed at positions close to a front-side end portion and an end portion on the rear side in the longitudinal direction of the side surface portion 50G along the depth direction +Z.

In addition, the support body 79 is provided with a clamping portion 792. The clamping portion 792 is a portion that clamps the upper and lower end portions of the long sides of the first member 72 from the upper and lower directions and movably supports the end portions.

Accordingly, the first member 72 is supported by the clamping portion 792 of the support body 79 and is movable with respect to the housing 50.

Further, a movement support frame portion 793 is provided in the support body 79. The movement support frame portion 793 is a portion that movably supports a moving shaft portion 822 of a roll contactor 82 of the displacement member 81, which will be described later. The roll contactor 82 is provided on the first member 72 as will be described later.

The movement support frame portion 793 is formed as a frame having a long hole space in the movement direction E of insertion and extraction. A length of the hole space of the movement support frame portion 793 in the longitudinal direction is set to a dimension in which a movable distance of the roll contactors 82 is kept at the above first distance L1.

Accordingly, the movable range of the roll contactor 82 is limited by the movement support frame portion 793 of the support body 79.

As a result, the first member 72 is movable with respect to the housing 50 by the first distance L1 via the roll contactor 82.

In addition, a long through-hole 722 is formed near the rear end portion of the first member 72 in the longitudinal direction (refer to FIG. 7B).

The long through-hole 722 is a hole that allows the fixing protrusion 509 (refer to FIG. 8 and the like) provided on the side surface portion 50G of the housing 50 to pass through and escape. The fixing protrusion 509 is a protrusion for attaching one end of an elastic member 74, which will be described later, and is, for example, a cylindrical protrusion.

The long through-hole 722 has a length of the long hole of the dimension L3 (refer to FIG. 8). The dimension L3 may be a dimension in which the fixing protrusion 509 does not interfere with the first member 72 and does not hinder the movement of the first member 72 in a case where the first member 72 moves. In a case where the dimension L3 is set as a length in a relationship of L3>L1, for example, with the above first distance L1 as a reference. In a case where a configuration in which the movement range of the first member 72 is restricted by the fixing protrusion 509 is adopted, the dimension L3 may be a length in a relationship of L3<L1.

Further, two holding protrusions 725 that holds the second member 73 to be movable are provided on a surface of the first member 72 on a side opposite to the housing 50.

The two holding protrusions 725 are, for example, cylindrical protrusions, and are disposed at predetermined intervals in the longitudinal direction of the second member 73.

The holding protrusion 725 is fitted into a long hole 732 for movement of the second member 73, which will be described later, and is used.

On the other hand, the second member 73 is a plate material having a substantially rectangular shape that extends long in the movement direction E of the housing 50.

The second member 73 is formed with a length in the longitudinal direction shorter than a length of the first member 72 in the longitudinal direction. The second member 73 has, for example, a length of approximately half the length of the first member 72 in the longitudinal direction.

In addition, the second member 73 is attached to a surface of the first member 72 on a side opposite to the housing 50 to be movable along the movement direction E of the housing 50.

The second member 73 is configured to move with respect to the first member 72 by a predetermined second distance L2. The predetermined second distance L2 (refer to FIG. 8) will be described later.

In addition, the second member 73 is provided with two long holes 732 for movement extending in the longitudinal direction thereof.

The long holes 732 for movement are disposed at a predetermined interval in the longitudinal direction of the second member 73.

A length of the long hole 732 for movement is set to a dimension such that the movable distance of the second member 73 is limited to the above second distance L2 (refer to FIG. 8).

The long hole 732 for movement is disposed in a state of being biased to the rear end portion side in the longitudinal direction of the second member 73.

The two holding protrusions 725 provided on the first member 72 are respectively fitted into the two long holes 732 for movement. A retainer is attached to the protrusion tip end of the holding protrusion 725 to prevent the holding protrusion 725 from coming off through the long hole 732 for movement.

Accordingly, the second member 73 is held in a state of being movable with respect to the holding protrusion 725 via the long hole 732 for movement. Further, the movable range of the second member 73 is limited by the length of the long hole 732 for movement.

As a result, the second member 73 is movable with respect to the first member 72 by the second distance L2. The second member 73 is disposed not to protrude from any of the end portions 72f and 72b of the first member 72 in a case where the second member 73 is moved by the second distance L2.

Further, the second member 73 is provided with a contact portion 78 at an end portion on a front side in the longitudinal direction (refer to FIGS. 7A and 7B).

The contact portion 78 is a portion that comes into contact with a stop member 95, which is a part of the cleaning mounting portion 90, in a process of insertion and extraction of the cleaning device 5.

The contact portion 78 is formed in a shape extending to hang down from the end portion on the front side of the second member 73.

While the contact portion 78 is in contact with the stop member 95, the contact portion 78 fixes a position of the second member 73 with respect to the cleaning mounting portion 90 at the time of insertion and extraction.

In addition, the contact portion 78 is stationary in a state of being close to an outer surface of the attachment plate 56 of the housing 50 while not being in contact with the stop member 95 (refer to FIG. 8). The stationary state of the contact portion 78 in this case is realized in a state where the end portion on the front side of the second member 73 of the long hole 732 for movement is in contact with the holding protrusion 725. In addition, the stationary state of the contact portion 78 in this case is maintained in a state where the first member 72 and the second member 73 are biased in the depth direction +Z by the elastic member 74 to be described later.

In addition, the first member 72 is biased toward the housing 50 in the depth direction +Z by a restoring force Fr1 of the elastic member 74 (refer to FIG. 8).

A tension coil spring is used as the elastic member 74. One end of the tension coil spring of the elastic member 74 is attached to the fixing protrusion 509 provided on the housing 50, and the other end is attached to an attachment protrusion 723 of the first member 72.

In addition, the second member 73 is biased toward the first member 72 in the depth direction +Z by a restoring force Fr2 of the elastic member 75 (refer to FIG. 8).

In other words, the first member 72 biases the second member 73 to be pulled in the depth direction +Z by the restoring force Fr2 of the elastic member 75. In addition, it can be said that the first member 72 and the second member 73 are elastically connected via the elastic member 75.

A tension coil spring is used as the elastic member 75. One end of the tension coil spring of the elastic member 75 is attached to an attachment protrusion 726 of the first member 72, and the other end is attached to an attachment protrusion 735 of the second member 73.

The restoring force Fr1 of the elastic member 74 and the restoring force Fr2 of the elastic member 75 are set to have such that the relationship Fr1<Fr2 is satisfied.

Specifically, the tension coil spring of the elastic member 74 has a characteristic in which a spring load thereof is smaller than a spring load of the tension coil spring of the elastic member 75. On the contrary, the tension coil spring of the elastic member 75 has a characteristic in which the spring load thereof is larger than the spring load of the tension coil spring of the elastic member 74.

As a result, the first member 72 and the second member 73 are drawn toward each other by the restoring force Fr2 of the elastic member 75 and are more likely to be maintained in an integrated state. In addition, the first member 72 and the second member 73 receive the restoring force Fr1 of the elastic member 74 in an integrated state.

Therefore, the first member 72 and the second member 73 are maintained in a state of being integrated with each other and being continuously biased in the depth direction +Z with respect to the housing 50. In this case, the first member 72 and the second member 73 are subject to movement restriction by the movement support frame portion 793 of the support body 79 through the roll contactor 82.

As a result, the first member 72 and the second member 73 are maintained in a state where the movement in the depth direction +Z is restricted.

On the other hand, in a stage where the first member 72 and the second member 73 receive an external force larger than the restoring force Fr2 of the elastic member 75, the first member 72 and the second member 73 relatively move.

The above stage in which the large external force is applied mainly occurs in the following cases. That is, the housing 50 moves in the insertion movement direction E1 after the contact portion 78 of the second member 73 comes into contact with the stop member 95 of the cleaning mounting portion 90.

### Displacement Member

Next, as shown in FIGS. 7A and 7B and the like, the displacement member 81 includes the roll contactor 82 and a cam member 85.

The roll contactor 82 is a rotatable member that is in contact with at least the cam member 85.

The roll contactor 82 can also be referred to as a roller. In addition, from the viewpoint that the roll contactor 82 is a member that comes into contact with the cam members 85 and serve as a power source that displaces the cam members 85, the roll contactors 82 are members for the driver link.

Two roll contactors 82 are provided at an interval in the longitudinal direction of the first member 72 of the moving member 71.

The roll contactor 82 is configured with a shaft portion 821 and a roll body 823.

The shaft portion 821 is a cylindrical shaft that rotatably supports the roll body 823.

The roll body 823 is a cylindrical rotating body that is rotatably provided with respect to the shaft portion 821.

The shaft portion 821 is provided vertically with respect to a surface of the first member 72 on a side opposite to the surface on which the second member 73 is disposed. The protruding tip end portion of the shaft portion 821 is supported to be movable on a linear upper side of the support portion 508 provided inside the housing 50 (refer to FIGS. 6A and 6B).

In addition, the shaft portion 821 has a moving shaft portion 822 that is fitted into the movement support frame portion 793 of the support body 79 and is movably supported (refer to FIGS. 6A, 6B, 9A, 9B, and 9C).

The cam member 85 is a member that receives the contact of the roll contactor 82 moving integrally with the moving member 71 and displaces the protective member 65 to be moved back and forth between the shielded position and the exposed position.

From the viewpoint that the cam member 85 is a member that is displaced following the movement of the roll contactor 82 for the driver link, the cam member 85 is a member for the follower link.

The cam member 85 is disposed at a position where the cam member 85 can face each of the two roll contactors 82 among the lower portion of the main body portion 651 of the protective member 65.

The cam member 85 is configured by two cam portions 852 provided on the support body 851 (refer to FIGS. 9A to 9C, and the like).

The support body 851 is a structure that supports the two cam portions 852 and reinforces the protective member 65. The support body 851 also serves as a structure to which the cam member 85 is attached to the protective member 65.

The support body 851 is, for example, a plate-shaped structure that is fitted and mounted to a lower portion of the main body portion 651 of the protective member 65. Accordingly, the support body 851 reinforces the protective member 65 including prevention of the occurrence of warping of the protective member 65 or the like.

The support body 851 is provided with, at a lower portion thereof, a plurality of opening portions 853 that open corresponding to the gap 653 of the main body portion 651 (refer to FIG. 7A).

The two cam portions 852 are plate cams having a first contact surface 85a, a second contact surface 85b, and a connection inclined surface 85c by using one surface of the support body 851 (refer to FIGS. 9A to 9C).

The first contact surface 85a is a cam surface that comes into contact with the roll contactor 82 to keep the protective member 65 in a state of being moved to the shielded position.

The first contact surface 85a is a parallel surface formed with a predetermined height difference (lifting amount) H with respect to the second contact surface 85b (refer to FIG. 9A). The predetermined height difference H is set to the same dimension as the movement distance between the shielded position and the exposed position of the protective member 65.

The first contact surface 85a is also a surface at a position farther away from the scraper 62 or the protective member 65 than the second contact surface 85b.

The second contact surface 85b is a cam surface that comes into contact with the roll contactor 82 to keep the protective member 65 in a state of being moved to the exposed position.

The second contact surface 85b is configured by using, for example, a part of a lower surface 851b of the support body 851.

The second contact surface 85b is also a surface at a position closer to the scraper 62 or the protective member 65 than the first contact surface 85a.

The connection inclined surface 85c is a cam surface connecting the first contact surface 85a and the second contact surface 85b in an inclined manner.

An angle (pressure angle) of the connection inclined surface 85c is set from the viewpoint of, for example, setting the movement speed of the protective member 65 and the amount of displacement of the protective member 65 to be in a desired relationship.

Incidentally, the above first distance L1 is set to a dimension in which the roll contactors 82 can move to reach both the first contact surface 85a and the second contact surface 85b.

### (4-3) Details of Cleaning Mounting Portion on Which Cleaning Device is Mounted

Next, the cleaning mounting portion 90 will be described in detail.

A pair of right and left guide members 93L and 93R are provided in the cleaning mounting portion 90 as described above.

As shown in FIGS. 2A and 2B, the guide members 93L and 93R have a first guide portion 93a, a second guide portion 93b, and a third guide portion 93c.

Each of the first guide portion 93a, the second guide portion 93b, and the third guide portion 93c is surrounded by a lower guide portion 931, an upper guide portion 932, and an outer lateral guide portion 933 (refer to FIG. 4).

The lower guide portion 931 and the upper guide portion 932 face each other with an interval required for the opposing guide surfaces to allow the guided portions 52L and 52R of the cleaning device 5 to pass therethrough.

The first guide portion 93a is a portion that moves the housing 50 such that the end portion 62e of the scraper 62 and the protective member 65 are maintained away from the outer peripheral surface of the intermediate transfer belt 31.

The first guide portion 93a is formed such that the guide surface of the lower guide portion 931 is at substantially the same height as the upper surface of the support plate 91.

The second guide portion 93b is a portion in which the housing 50 is displaced and moved in a direction close to the scraper 62 so that the end portion 62e of the scraper 62 starts to approach and come into contact with the outer peripheral surface of the intermediate transfer belt 31.

The second guide portion 93b is formed such that the guide surface of the lower guide portion 931 thereof serves as an inclined surface that connects the lower guide portions 931 of the first guide portion 93a and the third guide portion 93c. The second guide portion 93b is an upwardly inclined surface that is inclined at a gentle angle from the first guide portion 93a toward the third guide portion 93c. The guide surface of the lower guide portion 931b of the second guide portion 93b is set in consideration of, for example, a speed at which the end portion 62e of the scraper 62 comes into contact with the outer peripheral surface of the intermediate transfer belt 31, or the like.

The third guide portion 93c is a portion that moves the housing 50 such that the end portion 62e of the scraper 62 is maintained in contact with the outer peripheral surface of the intermediate transfer belt 31.

The third guide portion 93c is formed with a lower guide inclined surface portion 931c2 in front of a lower guide flat portion 931c1 (refer to FIG. 14B). The lower guide inclined surface portion 931c2 is an escape inclined surface that is inclined downward from the end portion on the rear side of the lower guide flat portion 931c1. This is for the reason that the guided portions 52L and 52R of the housing 50 are separated from the third guide portion 93c in a stage in which the main positioning surface portions 503 of the positioning pins 51A and 51B are fitted into the above positioning holes.

With regard to the first guide portion 93a, the lower guide portion 931 may be omitted by expanding the support plate 91 and using the upper surface thereof as a guide surface.

In a case where the first guide portion 93a in which the lower guide portion 931 is omitted is adopted, the third guide portion 93c may be configured as follows. In this case, the third guide portion 93c is disposed such that the lower guide portion 931 extends obliquely upward from a notched portion of the support plate 91.

In addition, the stop member 95 is disposed inside the cleaning mounting portion 90.

The stop member 95 is disposed, for example, at a position below the end portion on the front side of the support plate 91. The stop member 95 has a facing portion 95a that faces the contact portion 78 of the moving member 71 to be in contact with the contact portion 78 (refer to FIGS. 7A and 7B).

Further, a mounting attachment portion (not shown) is disposed at an end portion of the cleaning mounting portion 90 on the rear side.

A pair of positioning holes into which the pair of positioning pins 51A and 51B in the cleaning device 5 are fitted are provided in the mounting attachment portion.

In addition, the mounting attachment portion is provided with a through-hole through which the carrying-out pipe 53 in the cleaning device 5 passes.

In the cleaning mounting portion 90, a position where the positioning pins 51A and 51B are completely fitted into the positioning holes of the mounting attachment portion is defined as a mounting completion position of the cleaning device 5. Specifically, the mounting completion position is a position where the main positioning surface portions 503 of the positioning pins 51A and 51B are completely fitted into the positioning holes.

In addition, in the cleaning mounting portion 90, the position of the contact portion 78 of the moving member 71 in the cleaning device 5, which is in contact with the above stop member 95, is set to a position in front of the completion of the mounting of the cleaning device 5. For example, the position in front of the completion of the mounting is set to a position separated from the mounting completion position by about 80 mm. A distance from the mounting completion position to the position in front of the completion of the mounting is set from the viewpoint of, for example, reducing the operation force at the time of insertion and extraction of the cleaning device 5, reducing the wear loss of the portions that come into contact at the time of insertion and extraction, and the like.

Further, the position at which the guide members 93L and 93R are switched from the second guide portion 93b to the third guide portion 93c is set to be substantially the same as a position immediately before reaching the position in front of the completion of the mounting of the cleaning device 5.

### (4-4) Outline of Operation of Attaching and Detaching Cleaning Device and Operations of Protective Member and Moving Mechanism

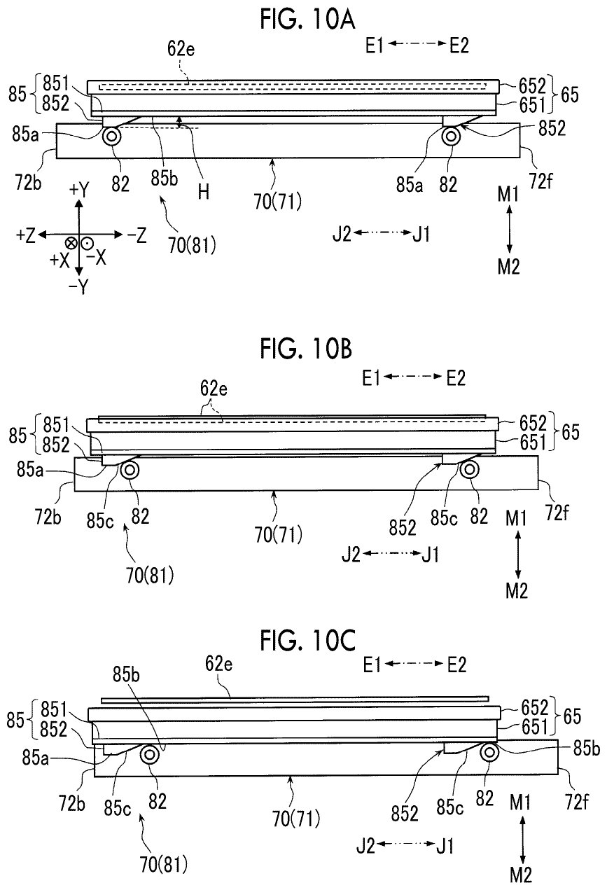

FIGS. 10A to 10C are explanatory views showing an outline of an operation of attaching and detaching the cleaning device 5 and operations of the protective member 65 and the moving mechanism 70.

### State Before Mounting and After Removing Cleaning Device

Before the cleaning device 5 is mounted on the cleaning mounting portion 90, the protective member 65 is moved to the shielded position by the moving mechanism 70 (refer to FIGS. 3 and 6B).

The state before the cleaning device 5 is mounted on the cleaning mounting portion 90 includes a case where the cleaning device 5 is removed from the cleaning mounting portion 90.

Therefore, even in a case where the cleaning device 5 is removed from the cleaning mounting portion 90, the protective member 65 is moved to the shielded position by the moving mechanism 70.

In this case, the moving mechanism 70 has the moving member 71 in the position before mounting (refer to FIGS. 5B and 8). The moving member 71 is stationary without being relatively moved with respect to the housing 50.

In addition, the moving mechanism 70 in this case is in a state where the roll contactors 82 and the cam members 85, which are the displacement members 81, are in the following state.

That is, the roll contactor 82 in the moving member 71 is located at a position contacting the first contact surface 85a of the cam portion 852 in the cam member 85 in the protective member 65 (refer to FIGS. 7A and 10A).

Accordingly, the cleaning device 5 before the mounting is in a state where the protective member 65 shields the end portion 62e of the scraper 62 (refer to FIG. 6B and FIG. 10A).

As a result, the end portion 62e of the scraper 62 in the cleaning device 5 is protected by the protective member 65 from unnecessary contact with the outside.

### Mounting Operation of Cleaning Device

Next, in a case where the cleaning device 5 is mounted on the cleaning mounting portion 90, the cleaning device 5 is held by the worker and moved toward the cleaning mounting portion 90 (refer to FIGS. 2A and 2B).

In this case, the cleaning device 5 is held by the worker who performs the work of mounting. The operator, for example, holds the bottom surface portion 50B of the housing 50 with one hand and holds the grip portion 55b of the end portion cover 55 with the other hand.

As a result, the cleaning device 5 moves from the inlet 90a in the insertion movement direction E1 and is inserted into the inside of the cleaning mounting portion 90.

In a case where the cleaning device 5 is inserted into the cleaning mounting portion 90, the protective member 65 is in a state of shielding the end portion 62e of the scraper 62 as a state before mounting (refer to FIG. 10A).

Therefore, in the cleaning device 5 in this case, there is no risk that the hand of the worker accidentally comes into contact with the end portion 62e of the scraper 62.

Then, in a case where the cleaning device 5 is started to be inserted into the cleaning mounting portion 90, the moving mechanism 70 remains in the same state as before the cleaning device 5 is mounted (refer to FIG. 10A).

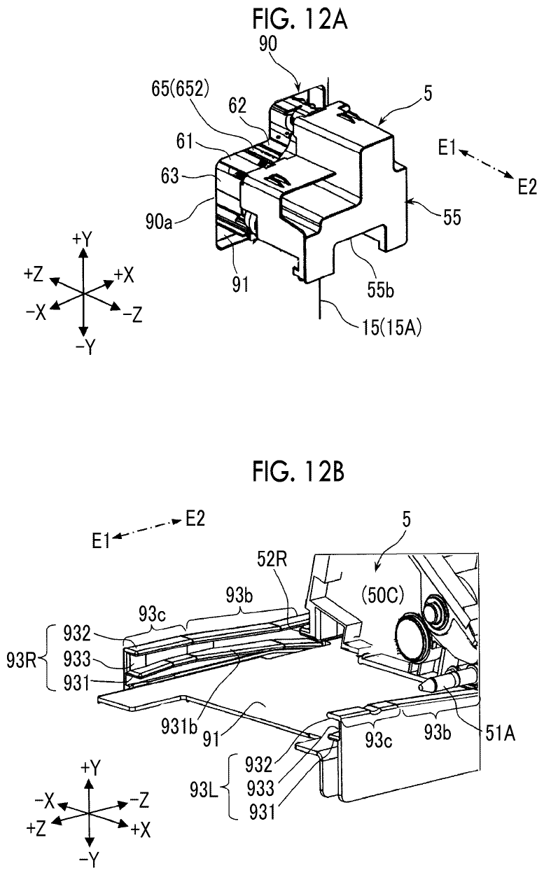

Subsequently, in the process of the insertion movement of the cleaning device 5, the contact portion 78 in the moving member 71 comes into contact with the stop member 95 in the cleaning mounting portion 90 (refer to FIGS. 12A and 12B).

In this case, the moving mechanism 70 is in a state where the moving member 71 is stopped with respect to the cleaning mounting portion 90. On the other hand, the moving member 71 in this case is in a state of starting to move relatively to the housing 50 in the direction of the arrow J1.

Accordingly, in the moving mechanism 70, the roll contactor 82 in the moving member 71 starts to face and come into contact with the connection inclined surface 85c of the cam portion 852 in the cam member 85 in the protective member 65 (refer to FIGS. 9B and 10B).

Further, due to this, the cam member 85, with the connection inclined surface 85c of the cam portion 852 supported from below by the roll contactor 82 that moves relatively in the direction of the arrow J1, starts to move downward.

As a result, the protective member 65 supported by the cam member 85 starts to move in a direction of an arrow M2 to descend.

Therefore, the end portion 62e of the scraper 62 at this stage is in a state where the end portion 62e starts to be released from the shielding by the protective member 65 (refer to FIG. 10B).

Subsequently, the cleaning device 5 is caused to move in the insertion movement direction E1 within the cleaning mounting portion 90 for mounting even after the contact portion 78 comes into contact with the stop member 95.

The cleaning device 5 is finally inserted into the cleaning mounting portion 90 up to the mounting completion position, and the mounting to the cleaning mounting portion 90 is completed.

In this case, the moving member 71 of the moving mechanism 70 further moves relative to the housing 50 in the direction of the arrow J1 and stops.

Accordingly, in the moving mechanism 70, the roll contactor 82 in the moving member 71 is in a state of facing and coming into contact with the second contact surface 85b of the cam portion 852 in the cam member 85 (refer to FIGS. 9C and 10C).

Further, due to this, the cam member 85 moves to the lowest position with the second contact surface 85b, which is the lower surface of the support body 851, being supported from below by the roll contactor 82. That is, the cam member 85 in this case is lowered by the height difference H (refer to FIG. 9A) between the first contact surface 85a and the second contact surface 85b.

As a result, the protective member 65 supported by the cam member 85 is in a state of being moved to the lowest position in the same manner as the cam member 85. That is, the protective member 65 in this case is in a state of being moved to the exposed position where the end portion 62e of the scraper 62 is exposed (refer to FIG. 10C).

Therefore, the end portion 62e of the scraper 62 of the cleaning device 5 at the mounting completion stage is in a state of being released from the shielding by the protective member 65 and being exposed (refer to FIG. 6A).

### Removal Operation of Cleaning Device

In a case where the cleaning device 5 is removed from the cleaning mounting portion 90, the cleaning device 5 is moved to be extracted from the cleaning mounting portion 90 by the worker.

That is, the cleaning device 5 in this case is moved in the extraction movement direction E2 inside the cleaning mounting portion 90.

In this case, the moving mechanism 70 operates in an order (FIG. 10C)→(FIG. 10B)→(FIG. 10A) opposite to the operation during mounting (FIG. 10A)→(FIG. 10B)→(FIG. 10C).

In this case, the moving member 71 of the moving mechanism 70 starts to move relative to the housing 50 of the cleaning device 5 that moves in the extraction movement direction E2 in the direction of the arrow J2.

Accordingly, in the moving mechanism 70, the roll contactor 82 in the moving member 71 starts to face and come into contact with the connection inclined surface 85c of the cam portion 852 of the cam member 85 (refer to FIG. 9B and FIG. 10B).

Further, due to this, the cam member 85, with the connection inclined surface 85c of the cam portion 852 supported from below by the roll contactor 82 that moves relatively in the direction of the arrow J2, starts to move upward.

As a result, the protective member 65 supported by the cam member 85 starts to move in a direction of an arrow M1 to ascend.

Therefore, the end portion 62e of the scraper 62 at this stage is in a state where shielding by the protective members 65 starts (refer to FIG. 10B).

Subsequently, in the process of the extraction movement of the cleaning device 5, the contact portion 78 in the moving member 71 is released from the contact with the stop member 95 in the cleaning mounting portion 90.

In this case, the moving mechanism 70 is in a state where the moving member 71 has completed the relative movement with respect to the housing 50 and is stationary with respect to the housing 50.

Accordingly, in the moving mechanism 70, the roll contactor 82 in the moving member 71 is in a state of facing and coming into contact with the first contact surface 85a of the cam portion 852 in the cam member 85 (refer to FIG. 10A).

Further, due to this, the first contact surface 85a of the cam portion 852 of the cam member 85 is supported from below by the roll contactor 82, and the cam member 85 moves to the uppermost position. The cam member 85 in this case is raised by the height difference H (refer to FIG. 9A) between the first contact surface 85a and the second contact surface 85b.

As a result, the protective member 65 supported by the cam member 85 is in a state of being moved to the uppermost position in the same manner as the cam member 85. That is, the protective member 65 in this case moves in the direction of the arrow M1 and is in a state of being moved to the shielded position for shielding the end portion 62e of the scraper 62 (refer to FIG. 10A).

In the cleaning device 5, the protective member 65 is in a state of being moved to the shielded position while moving in the extraction movement direction E2 inside the cleaning mounting portion 90.

Finally, the cleaning device 5 is finally extracted from the cleaning mounting portion 90 completely and is removed from the cleaning mounting portion 90.

In the removed cleaning device 5, the end portion 62e of the scraper 62 is in a state of being shielded by the protective member 65 as in the state before the mounting.

As described above, in the cleaning device 5, the switching movement between the exposed position and the shielded position of the protective member 65 can be performed by an operation of moving the cleaning device 5 for insertion and extraction in a case of attaching and detaching the cleaning device 5 to and from the cleaning mounting portion 90.

Therefore, in the cleaning device 5, the switching movement of the above protective member 65 can be easily performed as compared with a case where an operation other than the operation of moving the cleaning device 5 for insertion and extraction in a case of attaching and detaching the cleaning device 5 to and from the cleaning mounting portion 90. The operation other than the above operation is, for example, a dedicated operation or a related operation for the switching movement of the protective member 65 between the exposed position and the shielded position.

In addition, the cleaning device 5 improves the safety and workability in handling work of moving the cleaning device 5 to be inserted and extracted with respect to the cleaning mounting portion 90 in a case of attachment and detachment.

In addition, in the cleaning device 5, the movement of the protective member 65 from the shielded position to the exposed position is easily performed by the conversion of the movement direction, in which the movement is developed into directions M1 and M2 that intersect with the movement direction E for insertion and extraction of the cleaning device 5 by the moving mechanism 70.

### (4-5) Outline of Change in State at Time of Attachment and Detachment of Cleaning Device

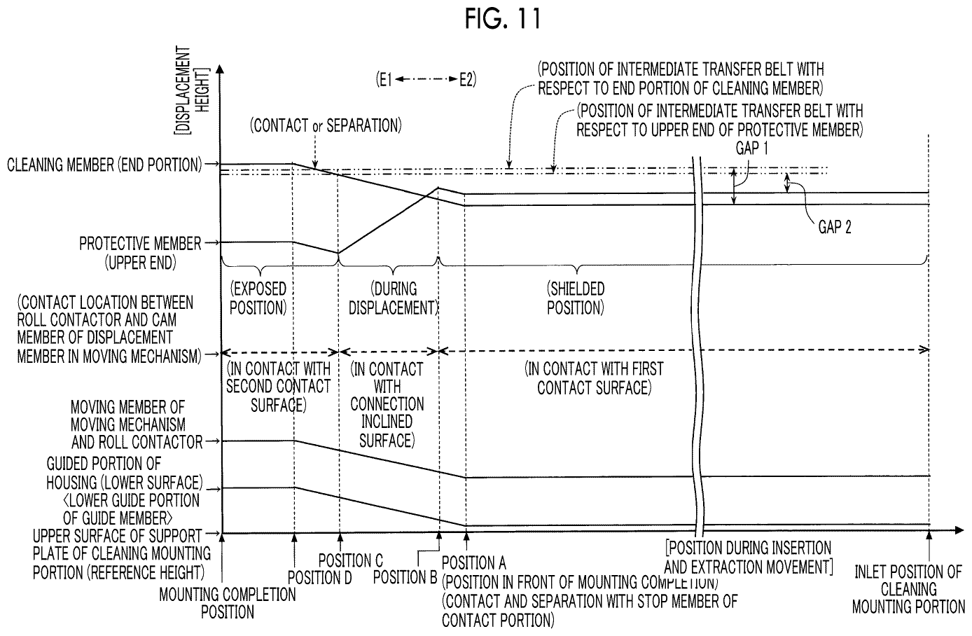

FIG. 11 is an explanatory view showing an outline of a change in a state in a case where the cleaning device 5 is attached to or detached from the cleaning mounting portion 90.

A horizontal axis in FIG. 11 shows a position of the end portion on the rear side of the cleaning device 5 in a case where the cleaning device 5 is moved to be inserted into or extracted from the cleaning mounting portion 90.

A vertical axis in FIG. 11 indicates a displacement height (displacement height) of some components of the cleaning device 5 and the cleaning mounting portion 90. The displacement height is a height displaced with respect to a reference height in a case where an upper surface of the support plate 91 of the cleaning mounting portion 90 is set as the reference height.

FIG. 11 also shows information on a contact location between the roll contactor 82 and the cam member 85 of the displacement member 81 in the moving mechanism 70.

The cleaning member described on the vertical axis of FIG. 11 is the scraper 62, and strictly speaking, is a height of the end portion 62e of the scraper 62.

An upper end of the protective member described on the vertical axis of FIG. 11 has a height of the upper end 65t of the protective member 65. Specifically, the upper end is the upper end 652t of the shielding portion 652 of the protective member 65.

The moving member of the moving mechanism described on the vertical axis of FIG. 11 is the first member 72 of the moving member 71, and strictly speaking, is the height of the roll contactor 82 disposed on the first member 72.

The height of the roll contactor 82 is, strictly speaking, the height of the upper end of the roll contactor 82.

The guided portion of the housing described on the vertical axis of FIG. 11 is the guided portions 52L and 52R of the housing 50, and strictly speaking, is the height of the lower surfaces of the guided portions 52L and 52R.

The guided portion of the housing also serves as a lower guide portion of the guide member that is enclosed by a parenthesis in the vertical axis. The guided portion of the housing is the guided portions 52L and 52R of the housing 50, and strictly speaking, is the height of the lower surfaces of the guided portions 52L and 52R.

In FIG. 11, a position of the intermediate transfer belt with respect to the end portion of the cleaning member and a position of the intermediate transfer belt with respect to the upper end of the protective member are described in a state of being deviated up and down with respect to the reference height.

This deviation is caused by the fact that the intermediate transfer belt 31 is inclined. First, each virtual vertical line extending from the end portion 62e of the scraper 62 and the upper end 65t of the protective member 65 in the vertical direction is extended to intersect the intermediate transfer belt 31. In this case, each position intersecting the intermediate transfer belt 31 is a position deviated in the up-down direction. This deviated position is reflected as the above deviation.

A gap 1 shown in FIG. 11 is a dimension in a case where the end portion 62e of the scraper 62 of the cleaning member is separated from the intermediate transfer belt 31. A gap 2 shown in FIG. 11 is a dimension in a case where the upper end 65t of the protective member 65 is separated from the intermediate transfer belt 31.

The contents of each position and the displacement height of some components described in FIG. 11 will be described as necessary in the description of the operation to be described later.

### (4-6) Details of Operation of Attaching and Detaching Cleaning Device and Operations of Protective Member and Moving Mechanism

Next, the operation of attaching and detaching the cleaning device 5 and the operations of the protective member 65 and the moving mechanism 70 will be described in more detail.

### State Before Mounting and After Removing Cleaning Device

Before the cleaning device 5 is mounted on the cleaning mounting portion 90, the protective member 65 is moved to the shielded position by the moving mechanism 70 as described above.

Further, even in a case where the cleaning device 5 is removed from the cleaning mounting portion 90, the protective member 65 is moved to the shielded position by the moving mechanism 70.

In this case, the moving mechanism 70 has the moving member 71 in the position before mounting (refer to FIGS. 5A, 5B, and 8).

The position before the mounting is a position in a case where the contact portion 78 of the moving member 71 is stationary in a state of being close to an outer surface of the attachment plate 56 of the housing 50. More specifically, the position before the mounting is a position where the end portion on the front side of the second member 73 of the long hole 732 for movement is in contact with the holding protrusion 725.

The moving member 71 in this case is biased in the depth direction +Z with respect to the housing 50 by receiving the restoring force Fr1 of the elastic member 74 (refer to FIG. 8). Specifically, the moving member 71 in this case is biased in the depth direction +Z in a state where the first member 72 and the second member 73 configuring the moving member 71 are integrated. The restoring force Fr1 of the elastic member 74 at the time before the mounting is set to an initial force amount.

Accordingly, the moving member 71 is stopped at the above position before the mounting.

In addition, the above stage before mounting includes a stage in a case where the cleaning device 5 is mounted on the cleaning mounting portion 90 and then removed.

In addition, the moving mechanism 70 in this case is in a state where the roll contactors 82 and the cam members 85, which are the displacement members 81, are in the following state.

That is, the roll contactor 82 in the moving member 71 is located at a position contacting the first contact surface 85a of the cam portion 852 in the cam member 85 in the protective member 65 (refer to FIGS. 7A and 9A).

Since the roll contactor 82 in this case is disposed on the moving member 71 that is stationary at the position before the mounting, the roll contactor 82 is also stationary in the same manner as the moving member 71.

As described above, the moving mechanism 70 is in a state in which the cam member 85 is separated upward from the roll contactor 82 by the height difference H in the cam portion 852 (refer to FIG. 9A).

Therefore, the protective member 65 is placed in a state of being moved to a position away from the roll contactor 82 by the cam member 85 in the moving mechanism 70. In other words, the protective member 65 is in a state of being moved in the direction of the arrow M1 by the moving mechanism 70.

The movement of the protective member 65 is a movement of being separated from the roll contactor 82 by the height difference H in the cam member 85 in the same manner as the cam member 85. In addition, the movement is achieved by the fact that the first contact surface 85a of the cam member 85 is a surface at a position farther from the protective member 65 than the second contact surface 85b.

Accordingly, the protective member 65 in this case is in a state in which the shielding portion 652 is located to stand in front of the end portion 62e of the scraper 62 (refer to FIG. 6B).

As a result, before the cleaning device 5 is mounted, the protective member 65 is moved to the shielded position by the moving mechanism 70.

### Mounting Operation of Cleaning Device

Next, in a case where the cleaning device 5 is mounted on the cleaning mounting portion 90, the cleaning device 5 is held by the worker and moved toward the cleaning mounting portion 90 (refer to FIGS. 2A and 2B).

In this case, the cleaning device 5 is brought close to the inlet 90a of the cleaning mounting portion 90, starting from the rear surface portion 50C of the housing 50.

As a result, the cleaning device 5 moves from the inlet 90a in the insertion movement direction E1 and is inserted into the inside of the cleaning mounting portion 90.

In a case where the cleaning device 5 is inserted, the pair of guided portions 52L and 52R are fitted into the guide members 93L and 93R in the cleaning mounting portion 90.

As a result, the cleaning device 5 moves in the insertion movement direction E1 inside the cleaning mounting portion 90 while being guided by the guide members 93L and 93R.

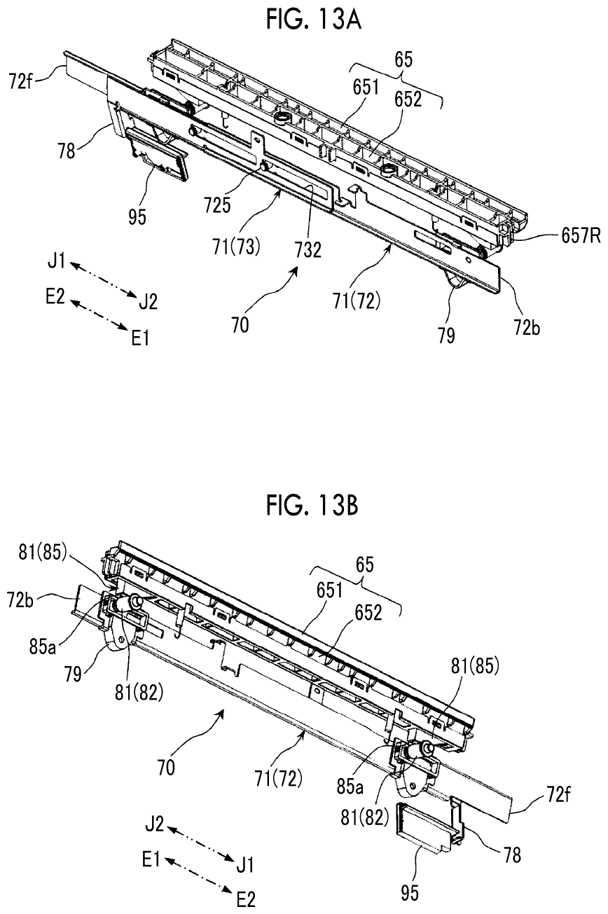

Subsequently, in the cleaning device 5, in the process of the insertion movement, the contact portion 78 in the moving member 71 comes into contact with the stop member 95 in the cleaning mounting portion 90 (refer to FIGS. 13A and 13B).

A position at which the contact portion 78 comes into contact with the stop member 95 is position A described on the horizontal axis in FIG. 11.

As a result, the cleaning device 5 is in a state where the moving member 71 is stopped in the cleaning mounting portion 90 while the housing 50 moves in the cleaning mounting portion 90.

In a case where the contact portion 78 comes into contact with the stop member 95, the cleaning device 5 is in a state where a portion on a front side including the end portion cover 55 is in a next state.

That is, the portion on the front side of the cleaning device 5 in this case is in a state of protruding from the inlet 90a of the cleaning mounting portion 90 (refer to FIG. 12A). In addition, in the portion on the front side of the cleaning device 5 in this case, a portion on the front side of the scraper 62 is exposed to the outside of the cleaning mounting portion 90.

However, in the cleaning device 5 in this case, the protective member 65 is at the shielded position, and the end portion 62e of the scraper 62 is shielded by the protective member 65.

As a result, the cleaning device 5 in this case is protected such that the end portion 62e of the scraper 62 does not come into unnecessary contact with the outside.

In addition, in the cleaning device 5 in this case, the guided portion 52R and the like in the rear surface portion 50C reach a position in front of the second guide portion 93b in the guide member 93R and the like (refer to FIG. 12B).

The position on the front side of the second guide portion 93b is also a position where the cleaning device 5 has substantially reached the position in front of the completion of the mounting. In addition, the position in front of the completion of the mounting of the cleaning device 5 substantially corresponds to the position A described on the horizontal axis of FIG. 11.

Then, until the contact portion 78 comes into contact with the stop member 95, the moving member 71 of the moving mechanism 70 moves integrally with the housing 50. That is, the moving member 71 moves together with the housing 50 in the insertion movement direction E1 until the contact portion 78 comes into contact with the stop member 95.

Therefore, in the moving mechanism 70 in this case, the roll contactor 82 of the moving member 71 is maintained in a state of facing and coming into contact with the first contact surface 85a of the cam member 85 (refer to FIG. 13B).

Accordingly, the moving mechanism 70 continues to maintain the state in which the protective member 65 is moved to the shielded position.

In addition, in the cleaning device 5 that moves until the contact portion 78 comes into contact with the stop member 95, the guided portions 52L and 52R are guided by the first guide portion 93a of the guide members 93L and 93R.

Accordingly, the cleaning device 5 moves in the cleaning mounting portion 90 in a state where the end portion 62e of the scraper 62 and the protective member 65 are separated from the intermediate transfer belt 31 to form the gaps 1 and 2 (refer to FIG. 11).

Therefore, the end portion 62e of the scraper 62 and the protective member 65 are prevented from inadvertently coming into contact with the intermediate transfer belt 31.

As a result, the cleaning device 5 can avoid damaging the intermediate transfer belt 31 due to the contact.

Incidentally, the gap 2 between the upper end 65t of the protective member 65 and the intermediate transfer belt 31 in this case is set as follows.

The above gap 2 is set to have a dimension smaller than a dimension of the gap 1 between the end portion 62e of the scraper 62 and the intermediate transfer belt 31.

Accordingly, even in a case where a behavior in which the intermediate transfer belt 31 approaches the end portion 62e of the scraper 62 occurs during the insertion and extraction movement of the cleaning device 5, the end portion 62e of the scraper 62 does not come into contact with the intermediate transfer belt 31.

That is, in this case, the protective member 65 is at the shielded position, and the upper end 65t is located above the end portion 62e of the scraper 62 (refer to FIG. 6B and FIG. 9A).

Therefore, the upper end 65t of the protective member 65 comes into contact with the intermediate transfer belt 31 on which the above behavior occurs.

As a result, in the cleaning device 5, even in a case where the above behavior occurs, the intermediate transfer belt 31 is prevented from coming into contact with the end portion 62e of the scraper 62.

Subsequently, the cleaning device 5 is caused to move in the insertion movement direction E1 within the cleaning mounting portion 90 for mounting even after the contact portion 78 comes into contact with the stop member 95.

The movement in this case is continued by an operation of the worker pushing the cleaning device 5 into the cleaning mounting portion 90.

The cleaning device 5 in this case, the guided portions 52L and 52R start to be guided to the second guide portion 93b of the guide members 93L and 93R (refer to FIG. 14B).

Accordingly, the guided portions 52L and 52R start to move on the upwardly inclined surface of the second guide portion 93b.

Therefore, the cleaning device 5 is gradually lifted in a direction in which an end portion on the rear side, including the rear surface portion 50C of the housing 50, floating from the support plate 91 of the cleaning mounting portion 90.

As a result, the cleaning device 5 is in a state where the end portion on the rear side starts to approach the outer peripheral surface of the intermediate transfer belt 31.

Along with this, portions on the rear side of the scraper 62 and the protective member 65 in the cleaning device 5 also starts to approach the outer peripheral surface of the intermediate transfer belt 31 (refer to FIG. 11).

On the other hand, the cleaning device 5 in this case has a state where a portion on the front side thereof enters the inside of the cleaning mounting portion 90. Specifically, the end portion cover 55 is in a state of starting to enter the inside of the cleaning mounting portion 90 (refer to FIG. 14A).

Accordingly, the scraper 62 and the protective member 65 enter the inside of the cleaning mounting portion 90 and are hidden from the outside in the cleaning device 5.

In the moving mechanism 70 in this case, the moving member 71 starts to move relative to a direction of an arrow J1 opposite to the housing 50 that moves in the insertion movement direction E1.

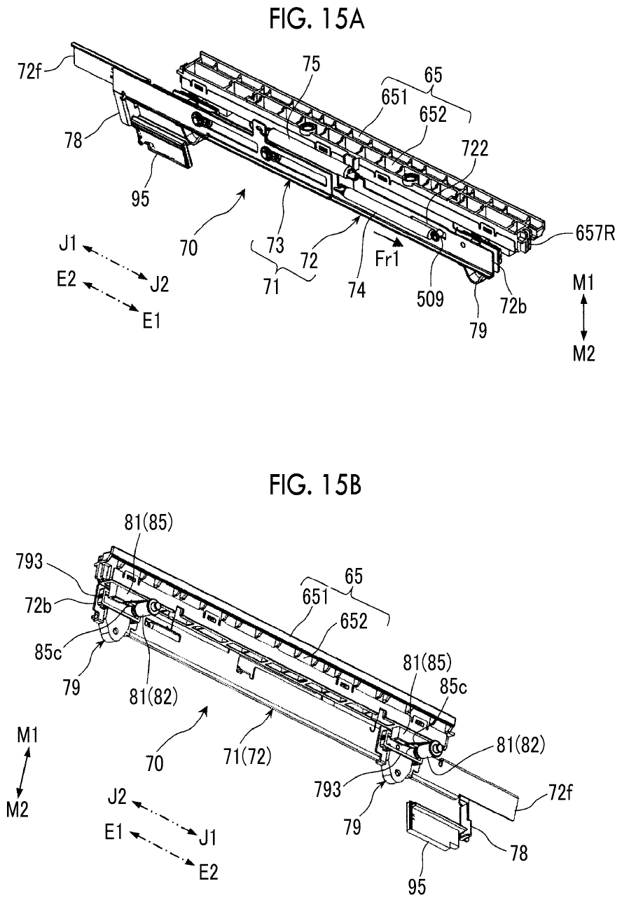

The moving member 71 starts to move relative to the direction of the arrow J1 with respect to the housing 50 in a state where the first member 72 and the second member 73 are integrated with each other (refer to FIG. 15A).

The relative movement of the moving member 71 with respect to the housing 50 is started at a position where the contact portion 78 comes into contact with the stop member 95. For this reason, a position where the contact portion 78 comes into contact with the stop member 95 is a movement start position of the moving member 71. The movement start position corresponds to a position A shown in FIG. 11.

In fact, the moving member 71 in this case is stopped and not moving with respect to the cleaning mounting portion 90. In this case, only the housing 50 excluding the moving member 71 moves in the insertion movement direction E1.

In addition, the tension coil spring of the elastic member 74 in this case is stretched by the housing 50 moving with respect to the stopped moving member 71. Accordingly, the restoring force Fr1 of the elastic member 74 increases.

Therefore, the moving member 71 in this case moves relative to the direction of the arrow J1 against the biasing in the depth direction +Z by the restoring force Fr1 of the elastic member 74. In other words, the housing 50 in this case moves in the insertion movement direction E1 against the biasing in the depth direction +Z by the restoring force Fr1 of the elastic member 74.

In addition, in the moving mechanism 70 in this case, the roll contactor 82 of the displacement member 81 starts to move relative to the direction of the arrow J1 with respect to the housing 50 together with the moving member 71.

Accordingly, the roll contactors 82 move from a position facing the first contact surface 85a of the cam member 85 to a position facing the connection inclined surface 85c.

In other words, in the cam member 85 in this case, the connection inclined surface 85c thereof starts to come into contact with the roll contactor 82 (refer to FIG. 9B and FIG. 15B).

As described above, the moving mechanism 70 moves to a position where the roll contactor 82 faces the connection inclined surface 85c of the cam member 85.

Therefore, the cam member 85 starts to move downward and approach the roll contactors 82 as the connection inclined surface 85c is supported from below by the roll contactor 82 that further moves in the direction of the arrow J1.

The start time of the downward movement of the cam member 85 is a time point at which the cam member 85 passes through a position B shown in FIG. 11.

As a result, the protective member 65 also starts to move downward and approach the roll contactor 82 by the cam member 85 in the moving mechanism 70. In other words, the protective member 65 starts to be displaced by the moving mechanism 70 to move in the direction of the arrow M2.

Here, in the cleaning device 5, the end portion 62e of the scraper 62 and the protective member 65 start to approach the outer peripheral surface of the intermediate transfer belt 31 through the guidance of the second guide portion 93b of the guide members 93L and 93R (refer to FIG. 11).

However, in the cleaning device 5, during the process of starting to approach, the roll contactor 82 faces the connection inclined surface 85c of the cam member 85 and starts to come into contact with the connection inclined surface 85c of the cam member 85 (refer to FIG. 11). Accordingly, the cam member 85 starts to move downward due to the movement with the connection inclined surface 85c of the roll contactor 82. In addition, the protective member 65 starts to move in the direction of the arrow M2 away from the outer peripheral surface of the intermediate transfer belt 31 as the cam member 85 descends.

Therefore, the upper end 65t of the protective member 65 is prevented from inadvertently coming into contact with the outer peripheral surface of the intermediate transfer belt 31 at a time point before the cleaning device 5 is completely mounted.

Subsequently, the moving member 71 of the moving mechanism 70 further moves relative to the direction of the arrow J1 with respect to the housing 50 by continuing the movement of the cleaning device 5 in the insertion movement direction E1.

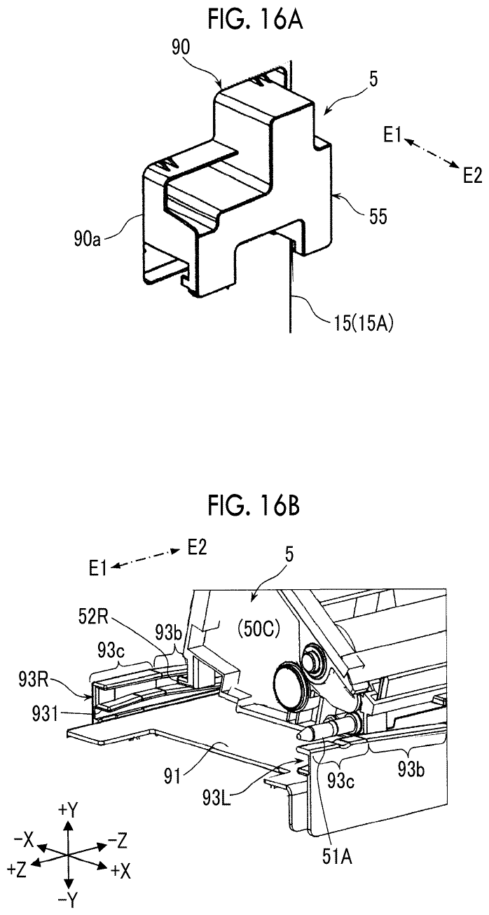

The cleaning device 5 in this case, the guided portions 52L and 52R are continuously guided to the second guide portion 93b of the guide members 93L and 93R (refer to FIG. 16B).

Accordingly, the cleaning device 5 is further lifted in a direction in which an end portion on the rear side, including the rear surface portion 50C of the housing 50, floating from the support plate 91 of the cleaning mounting portion 90.

As a result, the cleaning device 5 is in a state where the end portion on the rear side further approaches the outer peripheral surface of the intermediate transfer belt 31.

Along with this, a portion on the rear side of the scraper 62 in the cleaning device 5 is also in a state of further approaching the outer peripheral surface of the intermediate transfer belt 31 (refer to FIG. 11).

However, the protective member 65 in this case is moved to descend by the above operation of the moving mechanism 70 from a state where the end portion on the rear side of the cleaning device 5 approaches the outer peripheral surface of the intermediate transfer belt 31.

Therefore, the portion on the rear side of the protective member 65 is in a state of being gradually separated from the outer peripheral surface of the intermediate transfer belt 31 (refer to FIG. 11).

In addition, the cleaning device 5 in this case has a state where a portion on the front side thereof further enters the inside of the cleaning mounting portion 90. Specifically, the end portion cover 55 further enters the inside of the cleaning mounting portion 90 and comes into a hidden state (refer to FIG. 16A).

In the moving mechanism 70 in this case, the roll contactor 82 is also moved further in the direction of the arrow J1 with the relative movement of the moving member 71.

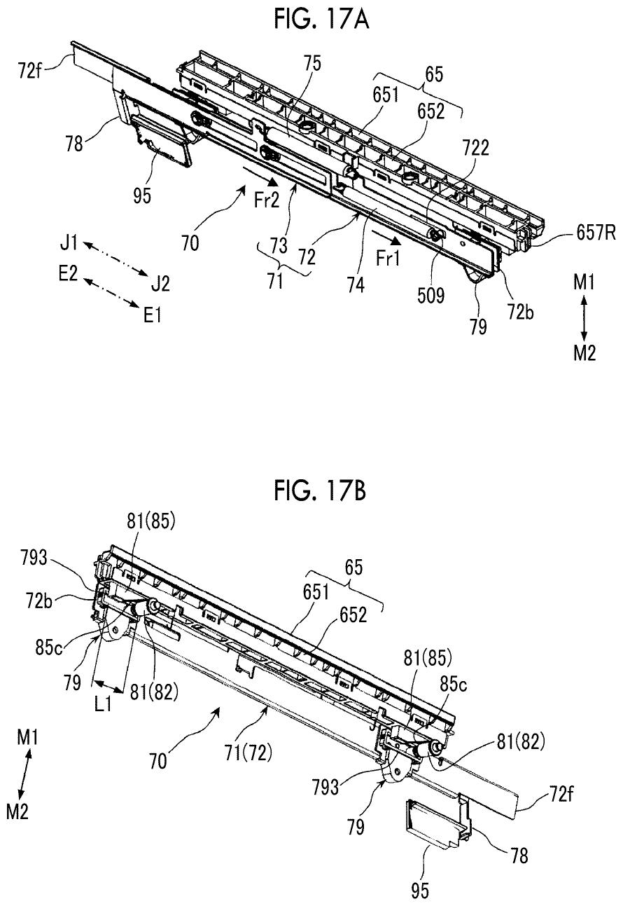

The further moving roll contactor 82 moves to a position where the roll contactor 82 faces and comes into contact with the second contact surface 85b of the cam member 85 and stops (refer to FIG. 9C and FIG. 17B).

Accordingly, the cam member 85 comes into a state where the second contact surface 85b is supported from below by the roll contactor 82. The cam member 85 in this case descends by a height difference H between the first contact surface 85a and the second contact surface 85b and stops.

In addition, the roll contactor 82 in this case actually stops after moving by a predetermined first distance L1 in the movement support frame portion 793 of the support body 79 (refer to FIG. 9C, FIG. 17B, and the like).

By stopping after the first distance L1 of the roll contactor 82 is moved, the moving member 71 is in a state where the relative movement in the direction of the arrow J1 is temporarily stopped. Specifically, the relative movement of the first member 72 of the moving member 71 is stopped.

As a result, the protective member 65 moves downward with respect to the housing 50 in a direction indicated by the arrow M2 as the cam member 85 moves downward.

The protective member 65 in this case also descends by the height difference H between the first contact surface 85a and the second contact surface 85b of the cam member 85, in the same manner as the cam member 85.

The descent of the protective member 65 by the height difference H is completed when the protective member 65 reaches a position C shown in FIG. 11.

As described above, the protective member 65 moves until the upper end 652t of the shielding portion 652 is positioned below the end portion 62e of the scraper 62 and stops (refer to FIG. 9C).

As a result, the protective member 65 in this case is in a state of being moved to the exposed position where the end portion 62e of the scraper 62 is exposed.

Incidentally, for a while after the protective member 65 is moved to the exposed position, the guided portions 52L and 52R of the cleaning device 5 are being guided to the second guide portion 93b (refer to FIG. 11). In other words, the cleaning device 5 is guided to approach the outer peripheral surface of the intermediate transfer belt 31 for a while even after passing through the position C shown in FIG. 11.

Therefore, the end portion 62e of the scraper 62 is in a state of being released from the shielded state by the protective member 65 and being completely exposed before coming into contact with the outer peripheral surface of the intermediate transfer belt 31.

In addition, the protective member 65 can reliably prevent the upper end 65t from coming into contact with the outer peripheral surface of the intermediate transfer belt 31 before completely moving to the exposed position.

The cleaning device 5 in this case is guided by the second guide portion 93b, but immediately before reaching the mounting completion position, the cleaning device 5 is in the following state.

That is, in the cleaning device 5, the end portion 62e of the scraper 62 starts to come into contact with the outer peripheral surface of the intermediate transfer belt 31 immediately before reaching the mounting completion position (refer to FIG. 11).

Finally, in a case where the cleaning device 5 is further moved within the insertion movement direction E1 in the cleaning mounting portion 90, the cleaning device 5 finally reaches the mounting completion position of the cleaning mounting portion 90.

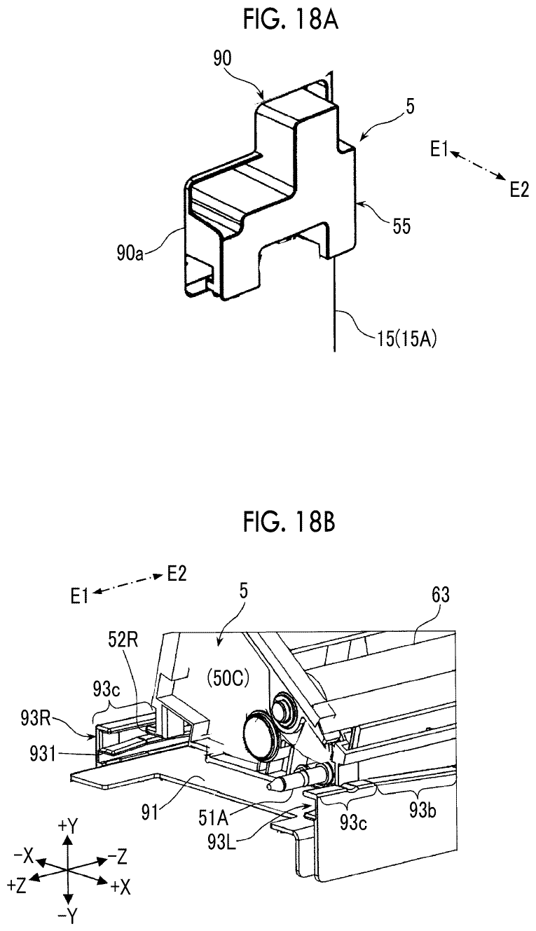

The cleaning device 5 immediately before reaching the mounting completion position is guided such that the guided portions 52L and 52R reach the third guide portion 93c of the guide members 93L and 93R (refer to FIG. 18B).

The time when the guided portions 52L and 52R reach the third guide portion 93c is when the guided portions 52L and 52R reach a position D shown in FIG. 11.

Accordingly, the cleaning device 5 is in a state where the end portion on the rear side including the rear surface portion 50C of the housing 50 is lifted to the maximum from the support plate 91 of the cleaning mounting portion 90 (refer to FIG. 4).

As a result, the cleaning device 5 is in a state where the end portion on the rear side is closest to the outer peripheral surface of the intermediate transfer belt 31.

Along with this, the end portion 62e of the scraper 62 in the cleaning device 5 is in a state where the portion on the rear side comes into contact with the outer peripheral surface of the intermediate transfer belt 31 (refer to FIGS. 4 and 11).

In the cleaning device 5 in the state, the end portion 62e of the scraper 62 comes into contact with the intermediate transfer belt 31 in a state of being slightly bitten into the intermediate transfer belt 31 (refer to FIG. 11).

On the other hand, the protective member 65 in this case is moved to the lowest position by the above operation of the moving mechanism 70. Therefore, in this case, the portion on the rear side of the protective member 65 is kept away from the outer peripheral surface of the intermediate transfer belt 31 (refer to FIGS. 4 and 11).

In addition, the cleaning device 5 in this case has a state where a portion on the front side thereof further enters the inside of the cleaning mounting portion 90.

Specifically, the end portion cover 55 is in a state of substantially entering the cleaning mounting portion 90 (refer to FIG. 18A). In this case, the end portion cover 55 has guided protruding portions 55c and 55d on the upper portion thereof guided by a guide portion in the cleaning mounting portion 90.

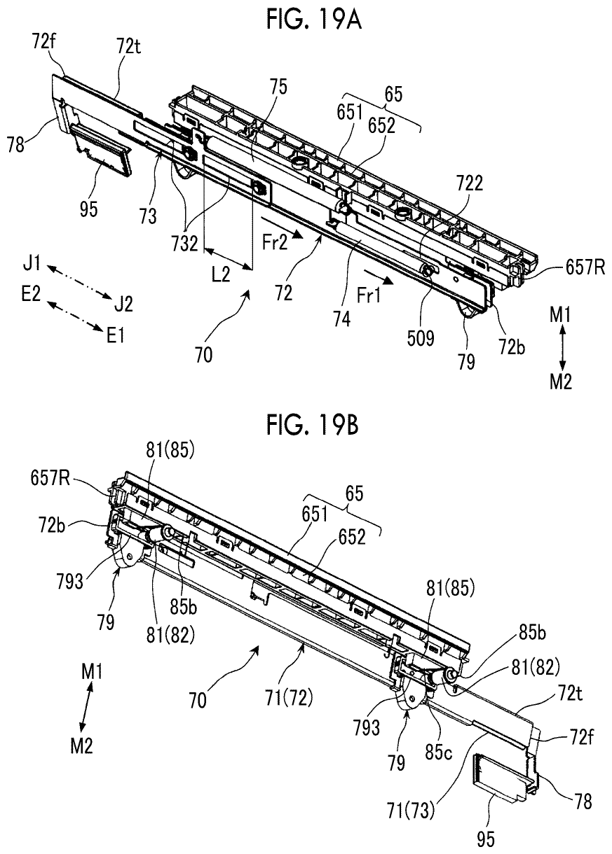

Further, in the moving mechanism 70 in this case, the second member 73 of the moving member 71 moves relative to the direction of the arrow J1 with respect to the first member 72 (refer to FIG. 19A).

The relative movement of the second member 73 in this case is restricted in the movable range by the long hole 732 for movement, and stops after moving the above second distance L2 (refer to FIG. 19A).

In this case, the contact portion 78 comes into contact with the stop member 95, and thus the second member 73 is in a stopped state with respect to the housing 50. Therefore, the relative movement of the second member 73 in this case is actually performed by the movement of the first member 72.

In addition, in this case, the first member 72 is stopped after the roll contactor 82 has moved the first distance L1. Therefore, the movement of the first member 72 in this case is performed by the first member 72 moving integrally with the housing 50 that moves in the insertion movement direction E1.

Further, the relative movement of the second member 73 with respect to the first member 72 in this case is performed against the biasing in the depth direction +Z direction by the restoring force Fr2 of the elastic member 75.

In this case, the biasing by the restoring force Fr2 of the elastic member 75 actually acts on the housing 50 that moves in the insertion movement direction E1 for mounting.

In a case where the cleaning device 5 is completely mounted, the housing 50 receives the following biasing.

The housing 50 is biased in a front direction-Z in which the restoring force Fr1 of the elastic member 74 and the restoring force Fr2 of the elastic member 75 are combined from the moving member 71.

### Completion of Mounting of Cleaning Device

In a case where the pair of positioning pins 51A and 51B are fitted into the positioning holes (not shown) on the rear side of the cleaning mounting portion 90 in the end portion on the rear side, the mounting of the cleaning device 5 is completed.

In addition, in the cleaning device 5 when the mounting is completed, the positioning pin (not shown) on the front side of the cleaning mounting portion 90 is fitted into the pair of positioning holes 57A and 57B in the end portion on the front side.

Then, in a case where the mounting of the cleaning device 5 is completed, the cleaning device 5 is finally fixed to the cleaning mounting portion 90 by fastening screws (not shown). Accordingly, after the mounting of the cleaning device 5 is completed, the cleaning device 5 is kept in a state where the cleaning device 5 is not extracted from inside the cleaning mounting portion 90.

Then, the cleaning device 5, in which the cleaning device 5 is mounted to the cleaning mounting portion 90, is in a state where the protective member 65 is moved to the exposed position and the end portion 62e of the scraper 62 is exposed.

Accordingly, the cleaning device 5 in this case is in a state where the end portion 62e of the scraper 62 is brought into contact with the outer peripheral surface of the intermediate transfer belt 31, enabling cleaning. (refer to FIG. 4).

As described above in detail, in the cleaning device 5, the movement of the protective member 65 from the shielded position to the exposed position can be easily performed by an operation of moving the cleaning device 5 in the insertion movement direction E1 in a case where the cleaning device 5 is mounted to the cleaning mounting portion 90.

In addition, in the cleaning device 5, in a case where the cleaning device 5 moves from the position in front of the mounting completion position (the position A shown in FIG. 11) to the mounting completion position, the end portion 62e of the scraper 62 starts to approach and displaces to come into contact with the intermediate transfer belt 31.

Therefore, in the cleaning device 5, during the insertion movement at the time of the mounting, the end portion 62e of the scraper 62 is in gentle contact with the intermediate transfer belt 31. In addition, during the insertion movement at the time of the mounting, the contact movement time in which the end portion 62e of the scraper 62 comes into contact with and moves on the intermediate transfer belt 31 can be reduced.

In addition, in the cleaning device 5, the moving mechanism 70 is configured to maintain the protective member 65 in a state of being moved to the shielded position except for between the mounting completion position and the position in front of the mounting completion position.

Therefore, in the cleaning device 5, the end portion 62e of the scraper 62 can be protected without being unnecessarily exposed in the process of the insertion movement at the time of the mounting.

In addition, in the cleaning device 5, the moving mechanism 70 is configured to start moving the protective member 65 from the shielded position to the exposed position while the end portion 62e of the scraper 62 starts to approach the intermediate transfer belt 31.

Therefore, in the cleaning device 5, the protective member 65 can be prevented from coming into contact with the intermediate transfer belt 31 between the mounting completion position and the front position thereof.

Further, in the cleaning device 5, the moving mechanism 70 is provided with the above moving member 71 and the above displacement member 81, and the moving member 71 is kept in a stopped state by coming into contact with the stop member 95, which is a part of the cleaning mounting portion 90, during the insertion movement at the time of the mounting and to be relatively moved with respect to the housing 50.

Therefore, in the cleaning device 5, the moving mechanism 70 can be configured simply by utilizing the insertion and extraction movement at the time of attachment and detachment of the cleaning device 5, as compared with a case where the moving mechanism 70 does not include the moving member 71 and the displacement member 81.

In addition, in the cleaning device 5, the moving member 71 is configured with the above first member 72 on which the roll contactor 82 is disposed and the above second member 73 on which the stop member 95 is disposed.

Therefore, in the cleaning device 5, a relative movement distance between the roll contactor 82 and the cam member 85 can be shortened even in a case where a movement distance from a movement start position where the moving member 71 starts moving with respect to the housing 50 during the insertion movement at the time of the mounting until the cleaning device 5 reaches the mounting completion position is long.

In addition, in the cleaning device 5, regarding the second member 73, during the insertion movement at the time of the mounting, the contact portion 78 contacts the stop member 95 of the cleaning mounting portion 90 and stops; after the first member 72 moves a predetermined first distance L1 and stops, the second member 73 is configured to start moving relative to the first member 72.

For this reason, in the cleaning device 5, even in a case where a movement distance from the above movement start position until the cleaning device 5 reaches the mounting completion position is long, the part of the movement distance can be absorbed by a relative movement of the second member 73 with respect to the first member 72.

### Removal Operation of Cleaning Device

In a case where the cleaning device 5 is removed from the cleaning mounting portion 90, the cleaning device 5 is moved to be extracted from the cleaning mounting portion 90 by the worker.

The operation of the protective member 65 or the moving mechanism 70 in the cleaning device 5 during the removal is almost the same as the operation of removing the cleaning device described in the above outline.

The movement of the end portion on the rear side of the cleaning device 5 is the same as the content shown in FIG. 11 (the content in a case of being viewed to shift from the left end to the right end of the horizontal axis).

Therefore, the cleaning device 5 performs an operation of moving the cleaning device 5 in the extraction movement direction E2, and thus the moving mechanism 70 operates to move the protective member 65 from the exposed position to the shielded position.

In addition, the movement of the protective member 65 from the exposed position to the shielded position in this case is performed while the cleaning device 5 is moving in the cleaning mounting portion 90 (refer to FIG. 11).

In a case where the cleaning device 5 is removed, the end portion 62e of the scraper 62 is shielded and protected by the protective member 65 from the middle of the removal work to the completion of the removal work.

Accordingly, even in a case where the cleaning device 5 is removed, the end portion 62e of the scraper 62 is appropriately shielded and protected by the protective member 65.

As a result, the end portion 62e of the scraper 62 can also be prevented from unnecessary contact with the outside in a case where the cleaning device 5 is removed.

As described above, in the cleaning device 5, the movement of the protective member 65 from the shielded position to the exposed position can be easily performed by an operation of moving the cleaning device 5 in the extraction movement direction E2 in a case where the cleaning device 5 is removed to the cleaning mounting portion 90.

### Modification Example

The present invention is not limited to the configuration examples described in the above exemplary embodiments. The present invention can be changed as necessary without departing from the gist of the invention described as means for addressing the problem.

Therefore, the present invention also includes Modification Example as exemplified below.

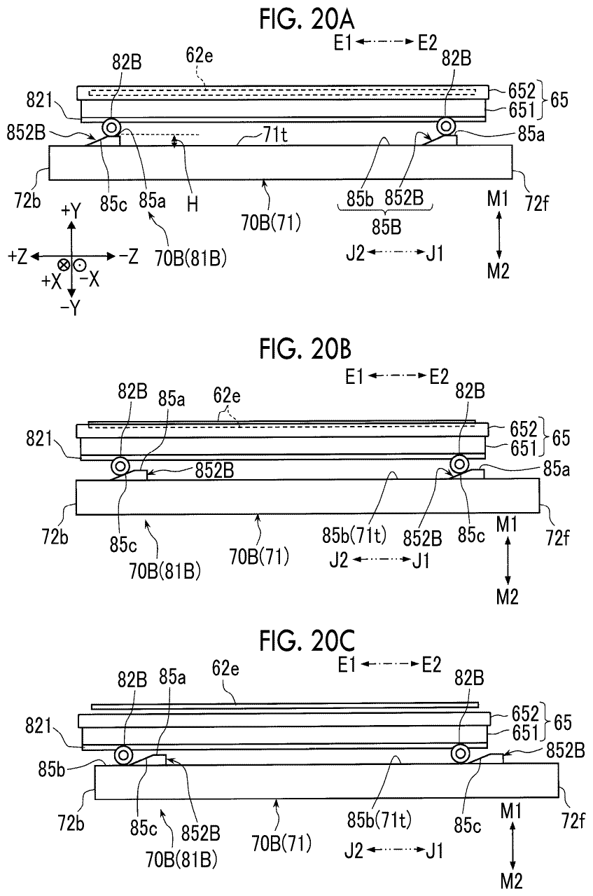

Instead of the moving mechanism 70, a moving mechanism 70B shown in FIGS. 20A to 20C may be adopted.

The moving mechanism 70B includes the moving member 71 in the first exemplary embodiment and a displacement member 81B consisting of a roll contactor 82B and a cam member 85B.

The roll contactor 82B in the displacement member 81B is disposed in the protective member 65. In addition, the roll contactor 82B is rotatably provided on a lower surface of the main body portion 651 of the protective member 65 via an attachment member (not shown).

The cam member 85B in the displacement member 81B is disposed in the moving member 71. In addition, the moving member 71 on which the cam member 85B is disposed is the first member 72 in first exemplary embodiment. Further, the moving member 71 moves relative to the directions of the arrows J1 and J2, which are the directions opposite to the insertion and extraction movement directions E1 and E2 of the housing 50 of the cleaning device 5.

Further, the cam member 85B is different from the cam member 85 in first exemplary embodiment in the following point, and is the same as the cam member 85 in the other points.

That is, the cam member 85B includes a cam portion 852B having a first contact surface 85a and a connection inclined surface 85c, but is different in that the cam member 85B is disposed such that the connection inclined surface 85c is present on the side of the first contact surface 85a in the insertion movement direction E1 (corresponding to the rear side). The cam member 85 in the first exemplary embodiment is disposed such that the connection inclined surface 85c is present on the side of the first contact surface 85a in the extraction movement direction E2 (corresponding to the front side) (refer to FIG. 10A).

In addition, the cam member 85B is different in that the second contact surface 85b is configured by using a flat portion of an upper end 71t of the moving member 71.

The first contact surface 85a is a surface parallel to a plane portion of the upper end 71t of the moving member 71 with a height difference H.

In addition, the moving mechanism 70B is configured to move the protective member 65 to the shielded position in a stage before the cleaning device 5 is mounted (refer to FIG. 20A). That is, at this stage, the first contact surface 85a of the cam member 85B is set to face and come into contact with the roll contactor 82B.

In addition, the moving mechanism 70B is configured to move the protective member 65 to the exposed position during the process and upon completion of mounting the cleaning device 5 (refer to FIG. 20C). That is, at this stage, the second contact surface 85b of the cam member 85B is set to face and come into contact with the roll contactor 82B by the relative movement with the housing 50 of the moving member 71.

Further, the moving mechanism 70B is configured to switch and move the protective member 65 between the shielded position and the exposed position in a process in which the moving member 71 is moved with respect to the housing 50.

That is, the position where the moving mechanism 70B faces and comes into contact with the roll contactor 82B of the cam member 85B due to the relative movement of the moving member 71 for the switching movement. Specifically, in the moving mechanism 70B, the position at which the first contact surface 85a or the second contact surface 85b faces and comes into contact with the roll contactor 82B is switched in response to the relative movement of the moving member 71 via the connection inclined surface 85c of the cam member 85B.

The cleaning member to be shielded and exposed by the protective member 65 may be a cleaning member other than the scraper 62.

As the cleaning member to be shielded and exposed may be, for example, fixed cleaning brushes.

The cleaning device 5 may be attachably and detachably mounted on a portion other than the cleaning mounting portion 90 provided in the housing 15 of the image forming apparatus 10. Specifically, a cleaning device that is attachable to and detachable from a cleaning mounting portion provided on a structure that can be extracted with respect to the housing 15 of the image forming apparatus 10 may be used.

In addition, the cleaning device 5 may have the movement direction E of the insertion and extraction not along the axial direction of the support roll 32a of the intermediate transfer belt 31 or the like but in a direction orthogonal to the axial direction.

Further, the cleaning device 5 may clean a target other than the intermediate transfer belt 31. Examples of the cleaning target include a transfer transport belt, a secondary transfer belt, and the like. The transfer transport belt is a rotating belt that holds and transports the sheet at a transfer position. The secondary transfer belt is a rotating belt that presses and transports the sheet to the secondary transfer position of the intermediate transfer belt 31.

The image forming apparatus to which the cleaning device 5 is applied is not limited to the image forming apparatus 10 according to the first exemplary embodiment.

The other image forming apparatus may be an image forming apparatus having a different number or type of image creating devices 20. Further, as another image forming apparatus, an image forming apparatus of a type that does not combine the image forming unit 11 with a separate sheet supply unit 12, a post-processing unit 13, and the like may be used.

### Supplementary Note

(((1)))

A cleaning device comprising:
a housing of the cleaning device that is moved to be inserted into and extracted from a cleaning mounting portion of an image forming apparatus including an image holding body that holds an image and rotates, and is attached to and detached from the cleaning mounting portion;
a cleaning member that is provided in the housing and cleans the image holding body by bringing a part of the cleaning member into contact with the image holding body;
a protective member that is provided to be movable in the housing, moves to a shielded position where the part of the cleaning member is shielded from an exposed position where the part is exposed, and protects the part; and
a moving mechanism that is provided to be movable in the housing and moves the protective member between the exposed position and the shielded position in conjunction with an operation of moving the housing to be inserted into and extracted from the cleaning mounting portion.
(((2)))

The cleaning device according to (((1))),
wherein the moving mechanism is a mechanism that moves the protective member back and forth in a direction intersecting a movement direction of the insertion and extraction to move the protective member between the exposed position and the shielded position.
(((3)))

The cleaning device according to (((1))) or (((2))),
wherein the housing is moved during an insertion and extraction movement while the part of the cleaning member and the protective member are kept away from the image holding body except for between a mounting completion position of the cleaning mounting portion and a position in front of the mounting completion position.
(((4)))

The cleaning device according to (((3))),
wherein in a case where the housing moves from the position in front of the mounting completion position to the mounting completion position, the housing is displaced so that the part of the cleaning member starts to approach the image holding body and comes into contact with the image holding body.
(((5)))

The cleaning device according to (((3))),
wherein the moving mechanism maintains the protective member in a state of being moved to the shielded position except for between the mounting completion position and the position in front of the mounting completion position.
(((6)))

The cleaning device according to (((4))),
wherein the moving mechanism starts moving the protective member from the shielded position to the exposed position while the part of the cleaning member starts to approach the image holding body.
(((7)))

The cleaning device according to (((1))),
wherein the moving mechanism is a mechanism that moves the protective member between the exposed position and the shielded position by changing a movement direction such that the protective member is moved back and forth in a direction intersecting a movement direction of the insertion and extraction.
(((8)))

The cleaning device according to (((7))),
wherein the moving mechanism includes a moving member that is provided in the housing and moves relative to the housing in a direction along and in a direction opposite to the movement direction of the insertion and extraction, and a displacement member that displaces the protective member to move the protective member back and forth in conjunction with a movement of the moving member, and
the moving member moves relative to the housing while being kept in a state of being stopped by contacting a part of the cleaning mounting portion during an insertion movement among the insertion and extraction.
(((9)))

The cleaning device according to (((8))),
wherein the displacement member includes a roll contactor disposed on the moving member and a cam member disposed on the protective member,
the roll contactor is a rotatable contactor that comes into contact with the cam member, and
the cam member is a plate cam having a first contact surface that comes into contact with the roll contactor to keep the protective member in a state of being moved to the shielded position, a second contact surface that comes into contact with the roll contactor to keep the protective member in a state of being moved to the exposed position, and a connection inclined surface connecting the first contact surface and the second contact surface to each other obliquely.
(((10)))

The cleaning device according to (((9))),
wherein the second contact surface is configured as a surface closer to the cleaning member than the first contact surface.
(((11)))

The cleaning device according to any one of (((7))) to (((10))),
wherein the housing has a guided portion that is guided by a guide member in the cleaning mounting portion during the insertion and extraction movement, and
the housing is moved while the guided portion is guided by the guide member so that the part of the cleaning member and the protective member are kept away from the image holding body except for between a mounting completion position of the cleaning mounting portion and a position in front of the mounting completion position.
(((12)))

The cleaning device according to (((11))),
wherein in a case where the housing moves from the position in front of the mounting completion position to the mounting completion position, the housing is moved while the guided portion is guided by the guide member so that the part of the cleaning member starts to approach the image holding body and comes into contact with the image holding body.
(((13)))

The cleaning device according to any one of (((9))) to (((12))),
wherein the moving mechanism keeps the roll contactor in continuous contact with the first contact surface except for between the mounting completion position and the position in front of the mounting completion position.
(((14)))

The cleaning device according to any one of (((9))) to (((13))),
wherein the moving mechanism causes the roll contactor to start coming into contact with the connection inclined surface from the first contact surface while the part of the cleaning member starts to approach the image holding body.
(((15)))

The cleaning device according to (((14))),
wherein the moving mechanism causes the roll contactor to come into contact with the second contact surface from the connection inclined surface at a stage where the mounting completion position is approached.
(((16)))

The cleaning device according to any one of (((9))) to (((15))),
wherein the moving member is configured with a first member in which the roll contactor is disposed and that is provided to be movable with respect to the housing by a predetermined first distance, and a second member in which a contact portion that contacts the part of the cleaning mounting portion and that is provided to be movable with respect to the first member by a predetermined second distance.
(((17)))

The cleaning device according to (((16))),
wherein the second member stops in a case where the contact portion contacts the part of the cleaning mounting portion during an insertion movement among the insertion and extraction, and starts to move with respect to the first member after the first member moves the predetermined first distance and stops.
(((18)))

An image forming apparatus comprising:
an image holding body that holds an image and rotates;
a cleaning device that cleans the image holding body; and
a cleaning mounting portion on which the cleaning device is attachably and detachably mounted by being moved for insertion and extraction,
wherein the cleaning device is configured by the cleaning device according to any one of (((1))) to (((17))).
(((19)))

The image forming apparatus according to (((18))),
wherein the cleaning mounting portion is provided with a guide member that guides a movement path of the housing of the cleaning device during an insertion and extraction movement, and
the guide member includes a first guide portion that moves the housing such that a part of the cleaning member and the protective member are kept away from the image holding body and a second guide portion that moves the housing by displacing the housing in a direction toward the cleaning member such that the part of the cleaning member starts to approach the image holding body and comes into contact with the image holding body.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A cleaning device comprising:
a housing of the cleaning device that is moved to be inserted into and extracted from a cleaning mounting portion of an image forming apparatus including an image holding body that holds an image and rotates, and is attached to and detached from the cleaning mounting portion;
a cleaning member that is provided in the housing and cleans the image holding body by bringing a part of the cleaning member into contact with the image holding body;
a protective member that is provided to be movable in the housing, moves to a shielded position where the part of the cleaning member is shielded from an exposed position where the part is exposed, and protects the part; and
a moving mechanism that is provided to be movable in the housing and moves the protective member between the exposed position and the shielded position in conjunction with an operation of moving the housing to be inserted into and extracted from the cleaning mounting portion.

2. The cleaning device according to claim 1,
wherein the moving mechanism is a mechanism that moves the protective member back and forth in a direction intersecting a movement direction of the insertion and extraction to move the protective member between the exposed position and the shielded position.

3. The cleaning device according to claim 2,
wherein the housing is moved during an insertion and extraction movement while the part of the cleaning member and the protective member are kept away from the image holding body except for between a mounting completion position of the cleaning mounting portion and a position in front of the mounting completion position.

4. The cleaning device according to claim 3,
wherein in a case where the housing moves from the position in front of the mounting completion position to the mounting completion position, the housing is displaced so that the part of the cleaning member starts to approach the image holding body and comes into contact with the image holding body.

5. The cleaning device according to claim 3,
wherein the moving mechanism maintains the protective member in a state of being moved to the shielded position except for between the mounting completion position and the position in front of the mounting completion position.

6. The cleaning device according to claim 4,
wherein the moving mechanism starts moving the protective member from the shielded position to the exposed position while the part of the cleaning member starts to approach the image holding body.

7. The cleaning device according to claim 1,
wherein the moving mechanism is a mechanism that moves the protective member between the exposed position and the shielded position by changing a movement direction such that the protective member is moved back and forth in a direction intersecting a movement direction of the insertion and extraction.

8. The cleaning device according to claim 7,
wherein the moving mechanism includes a moving member that is provided in the housing and moves relative to the housing in a direction along and in a direction opposite to the movement direction of the insertion and extraction, and a displacement member that displaces the protective member to move the protective member back and forth in conjunction with a movement of the moving member, and
the moving member moves relative to the housing while being kept in a state of being stopped by contacting a part of the cleaning mounting portion during an insertion movement among the insertion and extraction.

9. The cleaning device according to claim 8,
wherein the displacement member includes a roll contactor disposed on the moving member and a cam member disposed on the protective member,
the roll contactor is a rotatable contactor that comes into contact with the cam member, and
the cam member is a plate cam having a first contact surface that comes into contact with the roll contactor to keep the protective member in a state of being moved to the shielded position, a second contact surface that comes into contact with the roll contactor to keep the protective member in a state of being moved to the exposed position, and a connection inclined surface connecting the first contact surface and the second contact surface to each other obliquely.

10. The cleaning device according to claim 9,
wherein the second contact surface is configured as a surface closer to the cleaning member than the first contact surface.

11. The cleaning device according to claim 10,
wherein the housing has a guided portion that is guided by a guide member in the cleaning mounting portion during the insertion and extraction movement, and
the housing is moved while the guided portion is guided by the guide member so that the part of the cleaning member and the protective member are kept away from the image holding body except for between a mounting completion position of the cleaning mounting portion and a position in front of the mounting completion position.

12. The cleaning device according to claim 11,
wherein in a case where the housing moves from the position in front of the mounting completion position to the mounting completion position, the housing is moved while the guided portion is guided by the guide member so that the part of the cleaning member starts to approach the image holding body and comes into contact with the image holding body.

13. The cleaning device according to claim 12,
wherein the moving mechanism keeps the roll contactor in continuous contact with the first contact surface except for between the mounting completion position and the position in front of the mounting completion position.

14. The cleaning device according to claim 13,
wherein the moving mechanism causes the roll contactor to start coming into contact with the connection inclined surface from the first contact surface while the part of the cleaning member starts to approach the image holding body.

15. The cleaning device according to claim 14,
wherein the moving mechanism causes the roll contactor to come into contact with the second contact surface from the connection inclined surface at a stage where the mounting completion position is approached.

16. The cleaning device according to claim 9,
wherein the moving member is configured with a first member in which the roll contactor is disposed and that is provided to be movable with respect to the housing by a predetermined first distance, and a second member in which a contact portion that contacts the part of the cleaning mounting portion and that is provided to be movable with respect to the first member by a predetermined second distance.

17. The cleaning device according to claim 16,
wherein the second member stops in a case where the contact portion contacts the part of the cleaning mounting portion during an insertion movement among the insertion and extraction, and starts to move with respect to the first member after the first member moves the predetermined first distance and stops.

18. An image forming apparatus comprising:
an image holding body that holds an image and rotates;
a cleaning device that cleans the image holding body; and
a cleaning mounting portion on which the cleaning device is attachably and detachably mounted by being moved for insertion and extraction,
wherein the cleaning device is configured by the cleaning device according to claim 1.

19. An image forming apparatus comprising:
an image holding body that holds an image and rotates;
a cleaning device that cleans the image holding body; and
a cleaning mounting portion on which the cleaning device is attachably and detachably mounted by being moved for insertion and extraction,
wherein the cleaning device is configured by the cleaning device according to claim 2.

20. The image forming apparatus according to claim 18,
wherein the cleaning mounting portion is provided with a guide member that guides a movement path of the housing of the cleaning device during an insertion and extraction movement, and
the guide member includes a first guide portion that moves the housing such that a part of the cleaning member and the protective member are kept away from the image holding body and a second guide portion that moves the housing by displacing the housing in a direction toward the cleaning member such that the part of the cleaning member starts to approach the image holding body and comes into contact with the image holding body.
